(19) United States
(12) Patent Application Publication
(10) Pub. No.: US 2018/0032979 A1
(43) Pub. Date: Feb. 1, 2018

(54) INCENTIVIZING ACTIVATION OF AUDIO/VIDEO RECORDING AND COMMUNICATION DEVICES

(71) Applicant: BOT Home Automation, Inc., Santa Monica, CA (US)

(72) Inventor: James Siminoff, Pacific Palisades, CA (US)

(73) Assignee: BOT Home Automation, Inc., Santa Monica, CA (US)

(21) Appl. No.: 15/656,238

(22) Filed: Jul. 21, 2017

Related U.S. Application Data
(60) Provisional application No. 62/368,950, filed on Jul. 29, 2016.

(51) Int. Cl. G06Q 20/10; G06Q 30/02; H04N 5/232; H04N 7/18; H04N 5/77; G08B 13/196; H04W 4/00

(52) U.S. Cl. CPC G06Q 20/102; G08B 13/1966; G06Q 30/0207; H04W 4/008; H04N 7/186; H04N 5/77; H04N 5/23203

(57) ABSTRACT

Some aspects of the present embodiments provide a method for transferring A/V recording and communication devices to other parties for installation at structures such as homes. The distributed and/or installed devices may be in a pre-activation mode with limited functionality. For example, a video doorbell device in pre-activation mode may have similar functionalities as a traditional doorbell, such as sounding a signaling device (e.g., a bell or buzzer), when a front button of the doorbell is pressed. The camera and/or the recording capabilities of the video doorbell, however, may be disabled in the pre-activation mode. The homeowner (or renter or other occupant) may subsequently desire to activate the A/V recording and communication device. During the activation process, the homeowner may be required to submit a payment for the A/V recording and communication device.

### CROSS-REFERENCE TO RELATED APPLICATION

This application claims priority to Provisional Application Ser. No. 62/368,950, filed on Jul. 29, 2016, the entire contents of which are hereby incorporated by reference.

### TECHNICAL FIELD

The present embodiments relate to audio/video (A/V) recording and communication devices, including A/V recording and communication doorbells and A/V recording and communication security cameras. In particular, the present embodiments relate to improvements in the functionality of A/V recording and communication devices that strengthen the ability of such devices to reduce crime and enhance public safety.

### BACKGROUND

Home security is a concern for many homeowners and renters. Those seeking to protect or monitor their homes often wish to have video and audio communications with visitors, for example, those visiting an external door or entryway. Audio/video (A/V) recording and communication devices, such as doorbells and security cameras, provide this functionality, and can also aid in crime detection and prevention. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

### SUMMARY

The various embodiments of the present audio/video recording and communication devices and related methods and systems have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that audio/video (A/V) recording and communication devices, such as doorbells, can make neighborhoods safer. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

In light of the foregoing aspects of A/V recording and communication devices, it would be advantageous to increase the prevalence of A/V recording and communication devices in communities. One way of increasing the prevalence of A/V recording and communication devices in communities would be to give them away, free of charge, to homeowners, renters, landlords, etc. There is a cost, though, associated with producing A/V recording and communication devices. Thus, manufacturing such devices and simply giving them away is not a sustainable business model.

The present embodiments solve the foregoing problem by transferring, free of charge, A/V recording and communication devices to other parties for installation at structures such as homes. The parties to whom the devices are distributed may be people and/or businesses in the construction trade, such as homebuilders, contractors, and/or subcontractors. These parties/persons may then install the devices at structures that they are building, renovating, remodeling, etc. When the devices are distributed and/or installed, they may be in a pre-activation mode in which the devices have limited functionality. For example, if the devices are doorbells, they may be capable of functioning like a traditional doorbell whereby they may sound a signaling device (such as a bell or a buzzer) when the front button on the doorbell is pressed. The camera and/or the recording capabilities of the doorbells, however, may be disabled in the pre-activation mode. The homeowner (or renter or other occupant) may subsequently desire to activate the A/V recording and communication device. During the activation process, the homeowner may be required to submit a payment for the A/V recording and communication device. The manufacturer of the device is thus compensated for the device, and the prevalence of such devices in communities is increased because it may be more likely that a person will activate a device that is already installed in his or her home than it would be for that same person to purchase, install, and activate an A/V recording and communication device on his or her own.

In a first aspect, a method is provided, the method comprising transferring, free of charge, an audio/video (A/V) recording and communication device to another party for installation at a structure, the A/V recording and communication device being configured to be secured to the structure and including a processor, a camera, and a wireless communication module, the A/V recording and communication device being in a pre-activation mode, receiving an activation request signal, the activation request signal including a request to activate the A/V recording and communication device, in response to receiving the activation request signal, transmitting a request for payment for the A/V recording and communication device, receiving the payment for the A/V recording and communication device, and in response to receiving the payment, transmitting an activation signal to the A/V recording and communication device.

In an embodiment of the first aspect, the activation request signal is received from the A/V recording and communication device.

In another embodiment of the first aspect, the activation request signal is received from a client device.

In another embodiment of the first aspect, the A/V recording and communication device further comprises a button.

Another embodiment of the first aspect further comprises, in response to the button being pressed, the A/V recording and communication device providing instructions for activating the A/V recording and communication device.

In another embodiment of the first aspect, the instructions are audible and are provided via a speaker of the A/V recording and communication device.

In another embodiment of the first aspect, the instructions are written and are provided via an application executing on a client device.

In another embodiment of the first aspect, the instructions include information about a discount offer.

In another embodiment of the first aspect, the information indicates that the discount offer is a limited-time discount offer.

Another embodiment of the first aspect further comprises the wireless communication module of the A/V recording and communication device operating in a wireless access point mode and broadcasting a wireless network.

Another embodiment of the first aspect further comprises, in response to a client device connecting to the wireless network broadcast by the wireless communication module of the A/V recording and communication device, providing instructions for activating the A/V recording and communication device.

Another embodiment of the first aspect further comprises a name of the wireless network changing from a first wireless network name to a second wireless network name.

In another embodiment of the first aspect, the second wireless network name corresponds to a name of a holiday.

In another embodiment of the first aspect, a name of the wireless network includes a discount offer.

Another embodiment of the first aspect further comprises the wireless communication module of the A/V recording and communication device operating in a discoverable mode according to a short-range wireless protocol.

Another embodiment of the first aspect further comprises, in response to a client device connecting to the wireless communication module of the A/V recording and communication device, providing instructions for activating the A/V recording and communication device.

In another embodiment of the first aspect, the short-range wireless protocol comprises Bluetooth.

Another embodiment of the first aspect further comprises detecting, at a first time, an identifying characteristic of a person within a field of view of the camera and again detecting, at a second time after the first time, the identifying characteristic of the person within the field of view of the camera.

Another embodiment of the first aspect further comprises, in response to detecting, at the second time after the first time, the identifying characteristic of the person within the field of view of the camera, the A/V recording and communication device providing an announcement via a speaker of the A/V recording and communication device.

In another embodiment of the first aspect, the announcement encourages the person to activate the A/V recording and communication device.

Another embodiment of the first aspect further comprises, prior to receiving the activation request signal, wirelessly transmitting information to the A/V recording and communication device via a cellular network.

In another embodiment of the first aspect, the A/V recording and communication device comprises a doorbell.

Another embodiment of the first aspect further comprises, prior to transmitting the request for payment for the A/V recording and communication device, receiving a device identifier corresponding to the A/V recording and communication device.

Another embodiment of the first aspect further comprises, in response to receiving the device identifier corresponding to the A/V recording and communication device, determining a payment amount to be transmitted in the request for payment for the A/V recording and communication device.

In another embodiment of the first aspect, the payment amount is based on the received device identifier corresponding to the A/V recording and communication device.

In a second aspect, a method is provided, the method comprising transferring, free of charge, an audio/video (A/V) recording and communication device to another party for installation at a structure, the A/V recording and communication device being configured to be secured to the structure and including a processor, a camera, and a wireless communication module, the A/V recording and communication device being in a pre-activation mode, the wireless communication module of the A/V recording and communication device operating in a wireless access point mode and broadcasting a wireless network, and wirelessly transmitting information to the A/V recording and communication device via a cellular network.

In an embodiment of the second aspect, wirelessly transmitting information to the A/V recording and communication device via the cellular network comprises changing a name of the wireless network broadcast by the wireless communication module from a first wireless network name to a second wireless network name.

In another embodiment of the second aspect, the second wireless network name corresponds to a name of a holiday.

In another embodiment of the second aspect, at least one of the first wireless network name and the second wireless network name includes a discount offer.

Another embodiment of the second aspect further comprises receiving an activation request signal, the activation request signal including a request to activate the A/V recording and communication device.

Another embodiment of the second aspect further comprises, in response to receiving the activation request signal, transmitting a request for payment for the A/V recording and communication device.

Another embodiment of the second aspect further comprises receiving the payment for the A/V recording and communication device.

Another embodiment of the second aspect further comprises transmitting an activation signal to the A/V recording and communication device.

Another embodiment of the second aspect further comprises, prior to transmitting the request for payment for the A/V recording and communication device, receiving a device identifier corresponding to the A/V recording and communication device.

Another embodiment of the second aspect further comprises, in response to receiving the device identifier corresponding to the A/V recording and communication device, determining a payment amount to be transmitted in the request for payment for the A/V recording and communication device.

In another embodiment of the second aspect, the payment amount is based on the received device identifier corresponding to the A/V recording and communication device.

In another embodiment of the second aspect, the information wirelessly transmitted to the A/V recording and communication device via the cellular network includes information about an event that occurred within a defined radius of a location of the A/V recording and communication device.

In another embodiment of the second aspect, the A/V recording and communication device comprises a doorbell.

In a third aspect, a method is provided, the method comprising transferring, free of charge, an audio/video (A/V) recording and communication device to another party for installation at a structure, the A/V recording and communication device being configured to be secured to the structure and including a processor, a camera, and a wireless communication module, the A/V recording and communication device being in a pre-activation mode, receiving information about a location of the A/V recording and communication device, determining, based on the received location information, a street address corresponding to the received location information, and sending, to the determined street address, written instructions for activating the A/V recording and communication device.

In an embodiment of the third aspect, the received location information is received from the A/V recording and communication device.

In another embodiment of the third aspect, the received location information is received via a cellular network.

In another embodiment of the third aspect, the received location information is received from the another party.

In another embodiment of the third aspect, the received location information is received via a web portal.

Another embodiment of the third aspect further comprises receiving an activation request signal, the activation request signal including a request to activate the A/V recording and communication device.

Another embodiment of the third aspect further comprises, in response to receiving the activation request signal, transmitting a request for payment for the A/V recording and communication device.

Another embodiment of the third aspect further comprises receiving the payment for the A/V recording and communication device.

Another embodiment of the third aspect further comprises transmitting an activation signal to the A/V recording and communication device.

Another embodiment of the third aspect further comprises, prior to transmitting the request for payment for the A/V recording and communication device, receiving a device identifier corresponding to the A/V recording and communication device.

Another embodiment of the third aspect further comprises, in response to receiving the device identifier corresponding to the A/V recording and communication device, determining a payment amount to be transmitted in the request for payment for the A/V recording and communication device.

In another embodiment of the third aspect, the payment amount is based on the received device identifier corresponding to the A/V recording and communication device.

Another embodiment of the third aspect further comprises wirelessly transmitting information to the A/V recording and communication device via a cellular network.

In another embodiment of the third aspect, the information wirelessly transmitted to the A/V recording and communication device via the cellular network includes information about an event that occurred within a defined radius of a location of the A/V recording and communication device.

In another embodiment of the third aspect, the A/V recording and communication device comprises a doorbell.

In a fourth aspect, a method for activating an audio/video (A/V) recording and communication device that is in a pre-activation mode is provided, the method comprising transferring, free of charge, the A/V recording and communication device to a third-party for installation at a structure associated with a user, the A/V recording and communication device being configured to be secured to the structure in the pre-activation mode; receiving an activation request signal from a client device of the user, the activation request signal including a request to activate the A/V recording and communication device; in response to receiving the activation request signal, transmitting a request for payment for the A/V recording and communication device; and upon receiving the requested payment, transmitting an activation signal to the A/V recording and communication device.

In an embodiment of the fourth aspect, in the pre-activation mode a set of functionalities of the A/V recording and communication device is disabled.

In another embodiment of the fourth aspect, one functionality in the set of functionalities that is disabled comprises recording video images within a field of view of a camera of the A/V recording and communication device.

In another embodiment of the fourth aspect, the A/V recording and communication device comprises a button that when pressed, the A/V recording and communication device provides instructions for activating the A/V recording and communication device.

In another embodiment of the fourth aspect, the instructions are audible and are provided via a speaker of the A/V recording and communication device.

In another embodiment of the fourth aspect, the instructions are written and are provided via an application executing on a client device.

In another embodiment of the fourth aspect, the instructions include information about a limited-time discount offer.

Another embodiment of the fourth aspect further comprises, in response to the client device connecting to a wireless network broadcast by a wireless communication module of the A/V recording and communication device, providing instructions for activating the A/V recording and communication device.

Another embodiment of the fourth aspect further comprises changing a name of the wireless network from a first wireless network name to a second wireless network name.

In another embodiment of the fourth aspect, the second wireless network name corresponds to a name of a holiday.

In another embodiment of the fourth aspect, the second wireless network name further corresponds to a discount offer for the holiday.

Another embodiment of the fourth aspect further comprises, in response to the client device connecting to a wireless communication module of the A/V recording and communication device while the wireless communication module operates in a discoverable mode according to a short-range wireless protocol, providing instructions for activating the A/V recording and communication device.

In another embodiment of the fourth aspect, the short-range wireless protocol comprises Bluetooth.

Another embodiment of the fourth aspect further comprises detecting, at least at two different occasions, a same person within a field of view of a camera of the A/V recording and communication device.

Another embodiment of the fourth aspect further comprises, in response to detecting the same person within the field of view of the camera at the second occasion, providing an announcement via a speaker of the A/V recording and communication device.

In another embodiment of the fourth aspect, the announcement encourages the person to activate the A/V recording and communication device.

Another embodiment of the fourth aspect further comprises, prior to receiving the activation request signal, wirelessly transmitting information to the A/V recording and communication device via a cellular network.

In another embodiment of the fourth aspect, the A/V recording and communication device comprises a video doorbell.

Another embodiment of the fourth aspect further comprises, prior to transmitting the request for payment for the A/V recording and communication device, receiving a device identifier corresponding to the A/V recording and communication device.

Another embodiment of the fourth aspect further comprises, in response to receiving the device identifier corresponding to the A/V recording and communication device, determining a payment amount to be transmitted in the request for payment for the A/V recording and communication device based on the received device identifier.

### BRIEF DESCRIPTION OF THE DRAWINGS

The various embodiments of the present audio/video (A/V) recording and communication devices and related methods and systems now will be discussed in detail with an emphasis on highlighting the advantageous features. These embodiments depict the novel and non-obvious A/V recording and communication devices and related methods and systems shown in the accompanying drawings, which are for illustrative purposes only. These drawings include the following figures, in which like numerals indicate like parts:

FIG. 1 is a functional block diagram illustrating a system for streaming and storing A/V content captured by an audio/video (A/V) recording and communication device according to various aspects of the present disclosure;

FIG. 2 is a flowchart illustrating a process for streaming and storing A/V content from an A/V recording and communication device according to various aspects of the present disclosure;

FIG. 3 is a functional block diagram illustrating an embodiment of an A/V recording and communication device according to the present disclosure;

FIG. 4 is a front perspective view of an embodiment of an A/V recording and communication device according to the present disclosure;

FIG. 5 is a rear perspective view of the A/V recording and communication device of FIG. 4;

FIG. 6 is a partially exploded front perspective view of the A/V recording and communication device of FIG. 4 showing the cover removed;

FIGS. 7-9 are front perspective views of various internal components of the A/V recording and communication device of FIG. 4;

FIG. 10 is a right-side cross-sectional view of the A/V recording and communication device of FIG. 4 taken through the line 10-10 in FIG. 4;

FIGS. 11-13 are rear perspective views of various internal components of the A/V recording and communication device of FIG. 4;

FIG. 14 is a flowchart illustrating a process for transferring and activating an A/V recording and communication device according to various aspects of the present disclosure;

FIGS. 15 and 16 are sequence diagrams illustrating processes for activating an A/V recording and communication device according to various aspects of the present disclosure;

FIGS. 17-23 are flowcharts illustrating processes for transferring and activating an A/V recording and communication device according to various aspects of the present disclosure;

FIG. 24 is a functional block diagram of a client device on which the present embodiments may be implemented according to various aspects of the present disclosure; and

FIG. 25 is a functional block diagram of a general-purpose computing system on which the present embodiments may be implemented according to various aspects of present disclosure.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The embodiments of the present audio/video (A/V) recording and communication devices and related methods and systems are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

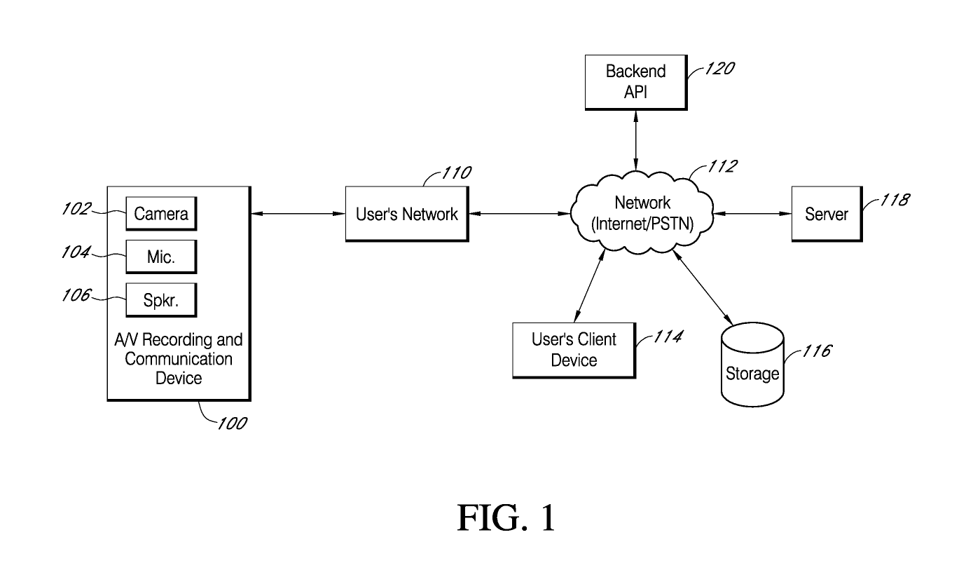

With reference to FIG. 1, the present embodiments include an audio/video (A/V) device 100, such as a doorbell. While the present disclosure provides numerous examples of methods and systems including A/V recording and communication doorbells, the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and functionality of the doorbells described herein, but without the front button and related components.

The A/V recording and communication device 100 may be located near the entrance to a structure (not shown), such as a dwelling, a business, a storage facility, etc. The A/V recording and communication device 100 includes a camera 102, a microphone 104, and a speaker 106. The camera 102 may comprise, for example, a high definition (HD) video camera, such as one capable of capturing video images at an image display resolution of 1080p or better. While not shown, the A/V recording and communication device 100 may also include other hardware and/or components, such as a housing, one or more motion sensors (and/or other types of sensors), a button, etc. The A/V recording and communication device 100 may further include similar componentry and/or functionality as the wireless communication doorbells described in US Patent Application Publication Nos. 2015/0022620 (application Ser. No. 14/499,828) and 2015/0022618 (application Ser. No. 14/334,922), both of which are incorporated herein by reference in their entireties as if fully set forth.

With further reference to FIG. 1, the A/V recording and communication device 100 communicates with a user's home wireless network 110, which may be for example a Wi-Fi network compatible with the IEEE 802.11 standard and/or other wireless communication standard(s). The user's wireless network 110 is connected to another network 112, which may comprise, for example, the Internet and/or a public switched telephone network (PSTN). As described below, the A/V recording and communication device 100 may communicate with the user's client device 114 via the home wireless network 110 and the network 112 (Internet/PSTN). The user's client device 114 may comprise, for example, a mobile telephone (may also be referred to as a cellular telephone), such as a smartphone, a personal digital assistant (PDA), or another communication device. The user's client device 114 comprises a display (not shown) and related components capable of displaying streaming and/or recorded video images. The user's client device 114 may also comprise a speaker and related components capable of broadcasting streaming and/or recorded audio, and may also comprise a microphone. The A/V recording and communication device 100 may also communicate with one or more remote storage device(s) 116 (may be referred to interchangeably as “cloud storage device(s)”), one or more servers 118, and/or a backend API (application programming interface)120 via the home wireless network 110 and the network 112 (Internet/PSTN). While FIG. 1 illustrates the storage device 116, the server 118, and the backend API 120 as components separate from the network 112, it is to be understood that the storage device 116, the server 118, and/or the backend API 120 may be considered to be components of the network 112.

The network 112 may be any wireless network or any wired network, or a combination thereof, configured to operatively couple the above mentioned modules, devices, and systems as shown in FIG. 1. For example, the network 112 may include one or more of the following: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access), TDMA (Time Division Multiple Access), FDMA (Frequency Division Multiple Access), and/or OFDMA (Orthogonal Frequency Division Multiple Access) cellular phone networks, GPS, CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-1394 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking.

According to one or more aspects of the present embodiments, when a person (may be referred to interchangeably as “visitor”) arrives at the A/V recording and communication device 100, the A/V recording and communication device 100 detects the visitor's presence and begins capturing video images within a field of view of the camera 102. The A/V communication device 100 may also capture audio through the microphone 104. The A/V recording and communication device 100 may detect the visitor's presence using a motion sensor, and/or by detecting that the visitor has depressed the button on the A/V recording and communication device 100.

In response to the detection of the visitor, the A/V recording and communication device 100 sends an alert to the user's client device 114 (FIG. 1) via the user's home wireless network 110 and the network 112. The A/V recording and communication device 100 also sends streaming video, and may also send streaming audio, to the user's client device 114. If the user answers the alert, two-way audio communication may then occur between the visitor and the user through the A/V recording and communication device 100 and the user's client device 114. The user may view the visitor throughout the duration of the call, but the visitor cannot see the user (unless the A/V recording and communication device 100 includes a display, which it may in some embodiments).

The video images captured by the camera 102 of the A/V recording and communication device 100 (and the audio captured by the microphone 104) may be uploaded to the cloud and recorded on the remote storage device 116 (FIG. 1). In some embodiments, the video and/or audio may be recorded on the remote storage device 116 even if the user chooses to ignore the alert sent to his or her client device 114.

With further reference to FIG. 1, the system may further comprise a backend API 120 including one or more components. A backend API (application programming interface) may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, or database layers, or other components. A backend API may, for example, comprise many such applications, each of which communicate with one another using their public APIs. In some embodiments, the API backend may hold the bulk of the user data and offer the user management capabilities, leaving the clients to have very limited state.

The backend API 120 illustrated FIG. 1 may include one or more APIs. An API is a set of routines, protocols, and tools for building software and applications. An API expresses a software component in terms of its operations, inputs, outputs, and underlying types, defining functionalities that are independent of their respective implementations, which allows definitions and implementations to vary without compromising the interface. Advantageously, an API may provide a programmer with access to an application's functionality without the programmer needing to modify the application itself, or even understand how the application works. An API may be for a web-based system, an operating system, or a database system, and it provides facilities to develop applications for that system using a given programming language. In addition to accessing databases or computer hardware like hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications.

The backend API 120 illustrated in FIG. 1 may further include one or more services (also referred to as network services). A network service is an application that provides data storage, manipulation, presentation, communication, and/or other capability. Network services are often implemented using a client-server architecture based on application-layer network protocols. Each service may be provided by a server component running on one or more computers (such as a dedicated server computer offering multiple services) and accessed via a network by client components running on other devices. However, the client and server components can both be run on the same machine. Clients and servers may have a user interface, and sometimes other hardware associated with them.

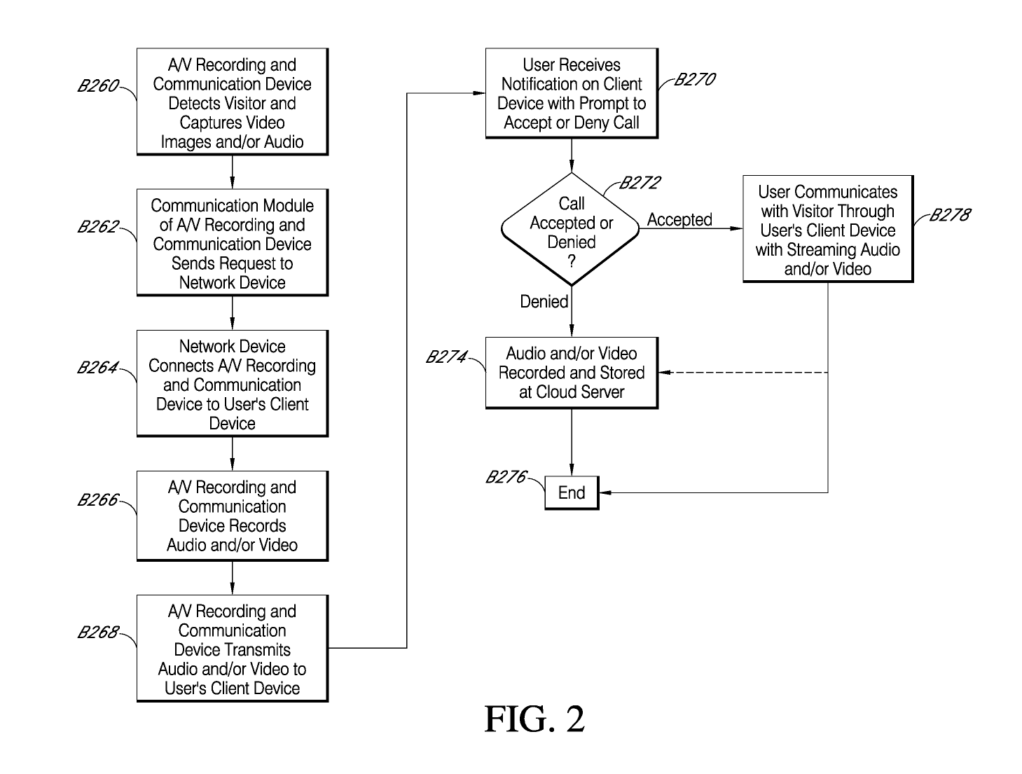

FIG. 2 is a flowchart illustrating a process for streaming and storing A/V content from the A/V recording and communication device 100 according to various aspects of the present disclosure. At block B260, the A/V recording and communication device 100 detects the visitor's presence and captures video images within a field of view of the camera 102. The A/V recording and communication device 100 may also capture audio through the microphone 104. As described above, the A/V recording and communication device 100 may detect the visitor's presence by detecting motion using the camera 102 and/or a motion sensor, and/or by detecting that the visitor has pressed a front button of the A/V recording and communication device 100 (if the A/V recording and communication device 100 is a doorbell). Also as described above, the video recording/capture may begin when the visitor is detected, or may begin earlier, as described below.

At block B262, a communication module of the A/V recording and communication device 100 sends a request, via the user's wireless network 110 and the network 112, to a device in the network 112. For example, the network device to which the request is sent may be a server such as the server 118. The server 118 may comprise a computer program and/or a machine that waits for requests from other machines or software (clients) and responds to them. A server typically processes data. One purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes. In another example, the network device to which the request is sent may be an API such as the backend API 120, which is described above.

In response to the request, at block B264 the network device may connect the A/V recording and communication device 100 to the user's client device 114 through the user's wireless network 110 and the network 112. At block B266, the A/V recording and communication device 100 may record available audio and/or video data using the camera 102, the microphone 104, and/or any other device/sensor available. At block B268, the audio and/or video data is transmitted (streamed) from the A/V recording and communication device 100 to the user's client device 114 via the user's wireless network 110 and the network 112. At block B270, the user may receive a notification on his or her client device 114 with a prompt to either accept or deny the call.

At block B272, the process determines whether the user has accepted or denied the call. If the user denies the notification, then the process advances to block B274, where the audio and/or video data is recorded and stored at a cloud server. The session then ends at block B276 and the connection between the A/V recording and communication device 100 and the user's client device 114 is terminated. If, however, the user accepts the notification, then at block B278 the user communicates with the visitor through the user's client device 114 while audio and/or video data captured by the camera 102, the microphone 104, and/or other devices/sensors is streamed to the user's client device 114. At the end of the call, the user may terminate the connection between the user's client device 114 and the A/V recording and communication device 100 and the session ends at block B276. In some embodiments, the audio and/or video data may be recorded and stored at a cloud server (block B274) even if the user accepts the notification and communicates with the visitor through the user's client device 114.

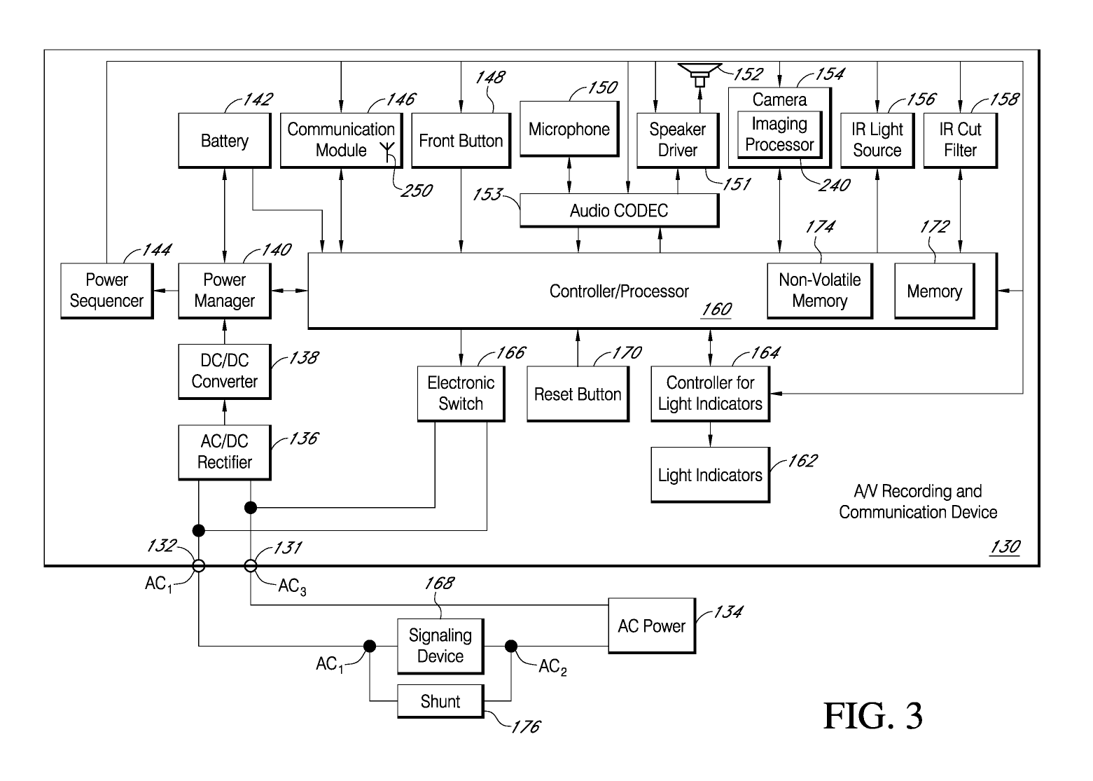

FIGS. 3-13 illustrate one embodiment of a low-power-consumption A/V recording and communication device 130 according to various aspects of the present disclosure. FIG. 3 is a functional block diagram illustrating various components of the A/V recording and communication device 130 and their relationships to one another. For example, the A/V recording and communication device 130 includes a pair of terminals 131, 132 configured to be connected to a source of external AC (alternating-current) power, such as a household AC power supply 134 (may also be referred to as AC mains). The AC power 134 may have a voltage in the range of 16-24 VAC, for example. The incoming AC power 134 may be converted to DC (direct-current) by an AC/DC rectifier 136. An output of the AC/DC rectifier 136 may be connected to an input of a DC/DC converter 138, which may step down the voltage from the output of the AC/DC rectifier 136 from 16-24 VDC to a lower voltage of about 5 VDC, for example. In various embodiments, the output of the DC/DC converter 138 may be in a range of from about 2.5 V to about 7.5 V, for example.

With further reference to FIG. 3, the output of the DC/DC converter 138 is connected to a power manager 140, which may comprise an integrated circuit including a processor core, memory, and/or programmable input/output peripherals. In one non-limiting example, the power manager 140 may be an off-the-shelf component, such as the BQ24773 chip manufactured by Texas Instruments. As described in detail below, the power manager 140 controls, among other things, an amount of power drawn from the external power supply 134, as well as an amount of supplemental power drawn from a battery 142, to power the A/V recording and communication device 130. The power manager 140 may, for example, limit the amount of power drawn from the external power supply 134 so that a threshold power draw is not exceeded. In one non-limiting example, the threshold power, as measured at the output of the DC/DC converter 138, may be equal to 1.4 A. The power manager 140 may also control an amount of power drawn from the external power supply 134 and directed to the battery 142 for recharging of the battery 142. An output of the power manager 140 is connected to a power sequencer 144, which controls a sequence of power delivery to other components of the A/V recording and communication device 130, including a communication module 146, a front button 148, a microphone 150, a speaker driver 151, a speaker 152, an audio CODEC (Coder-DECoder) 153, a camera 154, an infrared (IR) light source 156, an IR cut filter 158, a processor 160 (may also be referred to as a controller 160), a plurality of light indicators 162, and a controller 164 for the light indicators 162. Each of these components is described in detail below. The power sequencer 144 may comprise an integrated circuit including a processor core, memory, and/or programmable input/output peripherals. In one non-limiting example, the power sequencer 144 may be an off-the-shelf component, such as the RT5024 chip manufactured by Richtek.

With further reference to FIG. 3, the A/V recording and communication device 130 further comprises an electronic switch 166 that closes when the front button 148 is depressed. When the electronic switch 166 closes, power from the AC power source 134 is diverted through a signaling device 168 that is external to the A/V recording and communication device 130 to cause the signaling device 168 to emit a sound, as further described below. In one non-limiting example, the electronic switch 166 may be a triac device. The A/V recording and communication device 130 further comprises a reset button 170 configured to initiate a hard reset of the processor 160, as further described below.

With further reference to FIG. 3, the processor 160 may perform data processing and various other functions, as described below. The processor 160 may comprise an integrated circuit including a processor core, memory 172, non-volatile memory 174, and/or programmable input/output peripherals (not shown). The memory 172 may comprise, for example, DDR3 (double data rate type three synchronous dynamic random-access memory). The non-volatile memory 174 may comprise, for example, NAND flash memory. In the embodiment illustrated in FIG. 3, the memory 172 and the non-volatile memory 174 are illustrated within the box representing the processor 160. It is to be understood that the embodiment illustrated in FIG. 3 is merely an example, and in some embodiments the memory 172 and/or the non-volatile memory 174 are not necessarily physically incorporated with the processor 160. The memory 172 and/or the non-volatile memory 174, regardless of their physical location, may be shared by one or more other components (in addition to the processor 160) of the present A/V recording and communication device 130.

The transfer of digital audio between the user and a visitor may be compressed and decompressed using the audio CODEC 153, which is operatively coupled to the processor 160. When the visitor speaks, audio from the visitor is compressed by the audio CODEC 153, digital audio data is sent through the communication module 146 to the network 112 via the user's wireless network 110, routed by the server 118 and delivered to the user's client device 114. When the user speaks, after being transferred through the network 112, the user's wireless network 110, and the communication module 146, the digital audio data is decompressed by the audio CODEC 153 and emitted to the visitor through the speaker 152, which is driven by the speaker driver 151.

With further reference to FIG. 3, some of the present embodiments may include a shunt 176 connected in parallel with the signaling device 168. The shunt 176 facilitates the ability of the A/V recording and communication device 130 to draw power from the AC power source 134 without inadvertently triggering the signaling device 168. The shunt 176, during normal standby operation, presents a relatively low electrical impedance, such as a few ohms, across the terminals of the signaling device 168. Most of the current drawn by the A/V recording and communication device 130, therefore, flows through the shunt 176, and not through the signaling device 168. The shunt 176, however, contains electronic circuitry (described below) that switches the shunt 176 between a state of low impedance, such as a few ohms, for example, and a state of high impedance, such as >1K ohms, for example. When the front button 148 of the A/V recording and communication device 130 is pressed, the electronic switch 166 closes, causing the voltage from the AC power source 134 to be impressed mostly across the shunt 176 and the signaling device 168 in parallel, while a small amount of voltage, such as about 1V, is impressed across the electronic switch 166. The circuitry in the shunt 176 senses this voltage, and switches the shunt 176 to the high impedance state, so that power from the AC power source 134 is diverted through the signaling device 168. The diverted AC power 134 is above the threshold necessary to cause the signaling device 168 to emit a sound. Pressing the front button 148 of the device 130 therefore causes the signaling device 168 to sound, alerting any person(s) within the structure to which the device 130 is mounted that there is a visitor at the front door (or at another location corresponding to the location of the device 130). In one non-limiting example, the electronic switch 166 may be a triac device.

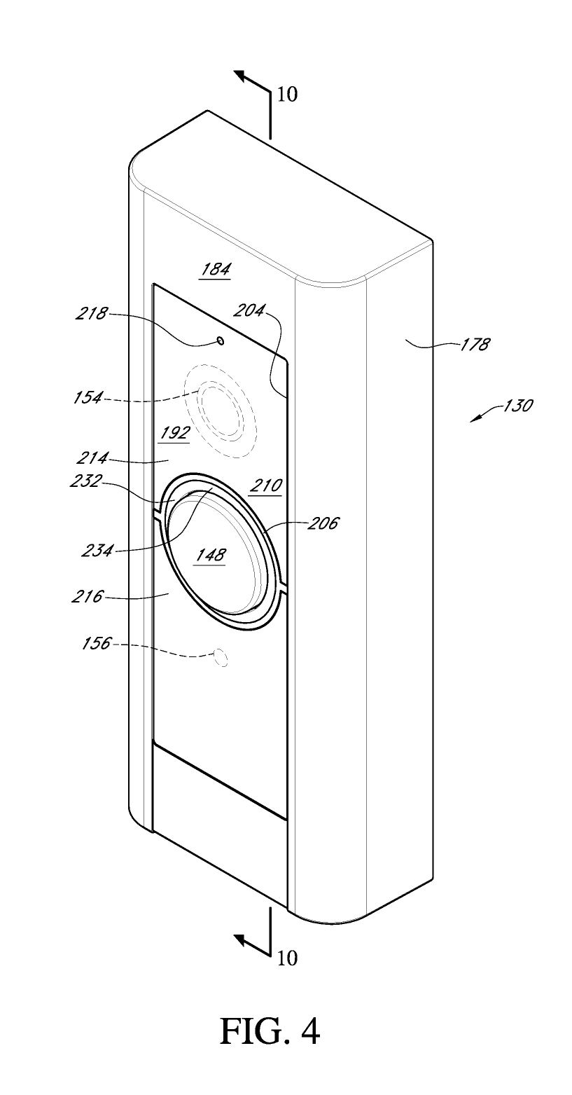

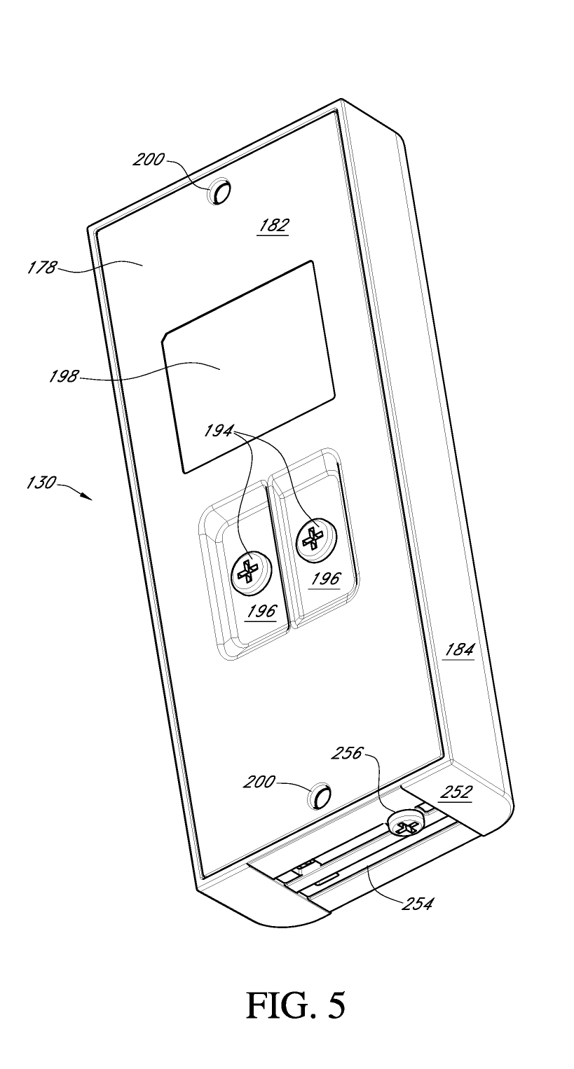

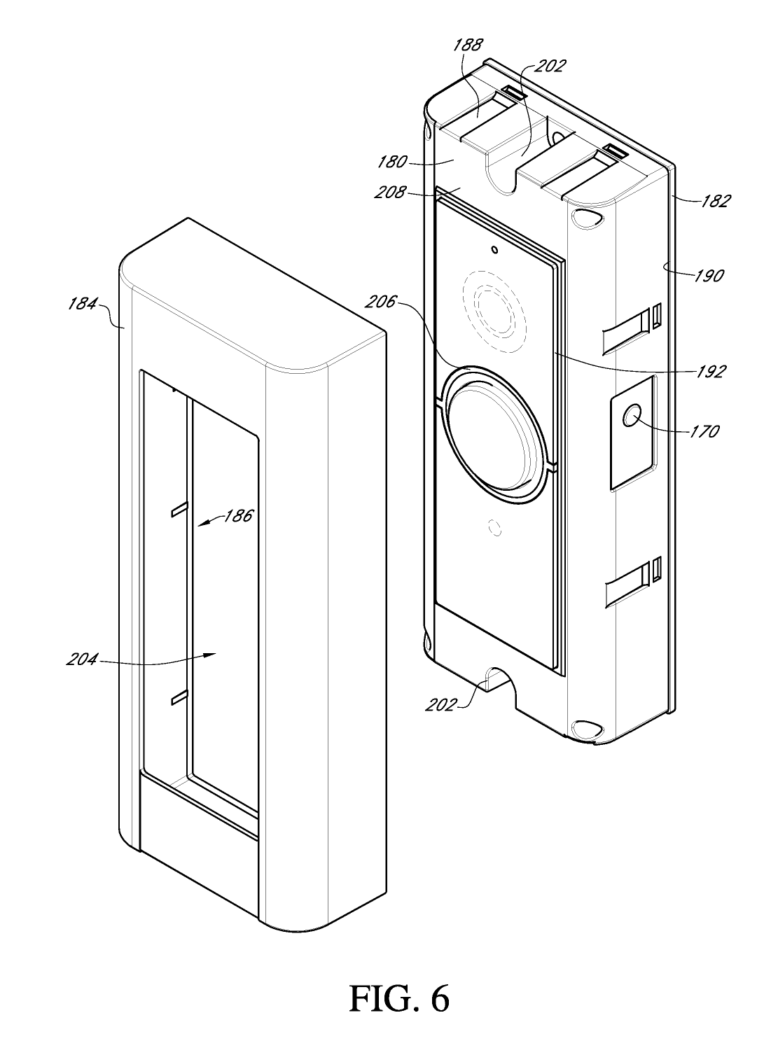

With reference to FIGS. 4-6, the A/V recording and communication device 130 further comprises a housing 178 having an enclosure 180 (FIG. 6), a back plate 182 secured to the rear of the enclosure 180, and a shell 184 overlying the enclosure 180. With reference to FIG. 6, the shell 184 includes a recess 186 that is sized and shaped to receive the enclosure 180 in a close-fitting engagement, such that outer surfaces of the enclosure 180 abut conforming inner surfaces of the shell 184. Exterior dimensions of the enclosure 180 may be closely matched with interior dimensions of the shell 184 such that friction maintains the shell 184 about the enclosure 180. Alternatively, or in addition, the enclosure 180 and/or the shell 184 may include mating features 188, such as one or more tabs, grooves, slots, posts, etc. to assist in maintaining the shell 184 about the enclosure 180. The back plate 182 is sized and shaped such that the edges of the back plate 182 extend outward from the edges of the enclosure 180, thereby creating a lip 190 against which the shell 184 abuts when the shell 184 is mated with the enclosure 180, as shown in FIGS. 4 and 5. In some embodiments, multiple shells 184 in different colors may be provided so that the end user may customize the appearance of his or her A/V recording and communication device 130. For example, the A/V recording and communication device 130 may be packaged and sold with multiple shells 184 in different colors in the same package.

With reference to FIG. 4, a front surface of the A/V recording and communication device 130 includes the button 148 (may also be referred to as front button 148, FIG. 3), which is operatively connected to the processor 160. In a process similar to that described above with reference to FIG. 2, when a visitor presses the front button 148, an alert may be sent to the user's client device to notify the user that someone is at his or her front door (or at another location corresponding to the location of the A/V recording and communication device 130). With further reference to FIG. 4, the A/V recording and communication device 130 further includes the camera 154, which is operatively connected to the processor 160, and which is located behind a shield 192. As described in detail below, the camera 154 is configured to capture video images from within its field of view. Those video images can be streamed to the user's client device and/or uploaded to a remote network device for later viewing according to a process similar to that described above with reference to FIG. 2.

With reference to FIG. 5, a pair of terminal screws 194 extends through the back plate 182. The terminal screws 194 are connected at their inner ends to the terminals 131, 132 (FIG. 3) within the A/V recording and communication device 130. The terminal screws 194 are configured to receive electrical wires to connect to the A/V recording and communication device 130, through the terminals 131, 132, to the household AC power supply 134 of the structure on which the A/V recording and communication device 130 is mounted. In the illustrated embodiment, the terminal screws 194 are located within a recessed portion 196 of the rear surface 198 of the back plate 182 so that the terminal screws 194 do not protrude from the outer envelope of the A/V recording and communication device 130. The A/V recording and communication device 130 can thus be mounted to a mounting surface with the rear surface 198 of the back plate 182 abutting the mounting surface. The back plate 182 includes apertures 200 adjacent its upper and lower edges to accommodate mounting hardware, such as screws (not shown), for securing the back plate 182 (and thus the A/V recording and communication device 130) to the mounting surface. With reference to FIG. 6, the enclosure 180 includes corresponding apertures 202 adjacent its upper and lower edges that align with the apertures 200 in the back plate 182 to accommodate the mounting hardware. In certain embodiments, the A/V recording and communication device 130 may include a mounting plate or bracket (not shown) to facilitate securing the A/V recording and communication device 130 to the mounting surface.

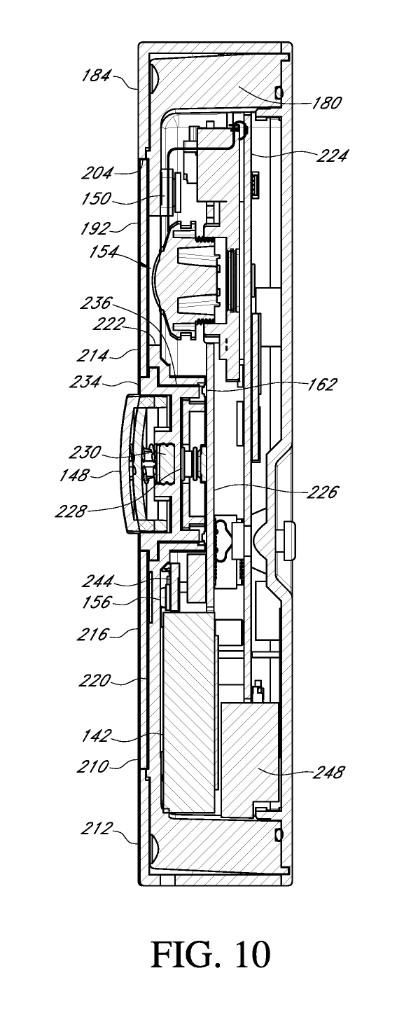

With further reference to FIG. 6, the shell 184 includes a central opening 204 in a front surface. The central opening 204 is sized and shaped to accommodate the shield 192. In the illustrated embodiment, the shield 192 is substantially rectangular, and includes a central opening 206 through which the front button 148 protrudes. The shield 192 defines a plane parallel to and in front of a front surface 208 of the enclosure 180. When the shell 184 is mated with the enclosure 180, as shown in FIGS. 4 and 10, the shield 192 resides within the central opening 204 of the shell 184 such that a front surface 210 of the shield 192 is substantially flush with a front surface 212 of the shell 184 and there is little or no gap (FIG. 4) between the outer edges of the shield 192 and the inner edges of the central opening 204 in the shell 184.

With further reference to FIG. 6, the shield 192 includes an upper portion 214 (located above and to the sides of the front button 148) and a lower portion 216 (located below and to the sides of the front button 148). The upper and lower portions 214, 216 of the shield 192 may be separate pieces, and may comprise different materials. The upper portion 214 of the shield 192 may be transparent or translucent so that it does not interfere with the field of view of the camera 154. For example, in certain embodiments the upper portion 214 of the shield 192 may comprise glass or plastic. As described in detail below, the microphone 150, which is operatively connected to the processor 160, is located behind the upper portion 214 of the shield 192. The upper portion 214, therefore, may include an opening 218 that facilitates the passage of sound through the shield 192 so that the microphone 150 is better able to pick up sounds from the area around the A/V recording and communication device 130.

The lower portion 216 of the shield 192 may comprise a material that is substantially transparent to infrared (IR) light, but partially or mostly opaque with respect to light in the visible spectrum. For example, in certain embodiments the lower portion 216 of the shield 192 may comprise a plastic, such as polycarbonate. The lower portion 216 of the shield 192, therefore, does not interfere with transmission of IR light from the IR light source 156, which is located behind the lower portion 216. As described in detail below, the IR light source 156 and the IR cut filter 158, which are both operatively connected to the processor 160, facilitate “night vision” functionality of the camera 154.

The upper portion 214 and/or the lower portion 216 of the shield 192 may abut an underlying cover 220 (FIG. 10), which may be integral with the enclosure 180 or may be a separate piece. The cover 220, which may be opaque, may include a first opening 222 corresponding to the location of the camera 154, a second opening (not shown) corresponding to the location of the microphone 150 and the opening 218 in the upper portion 214 of the shield 192, and a third opening (not shown) corresponding to the location of the IR light source 156.

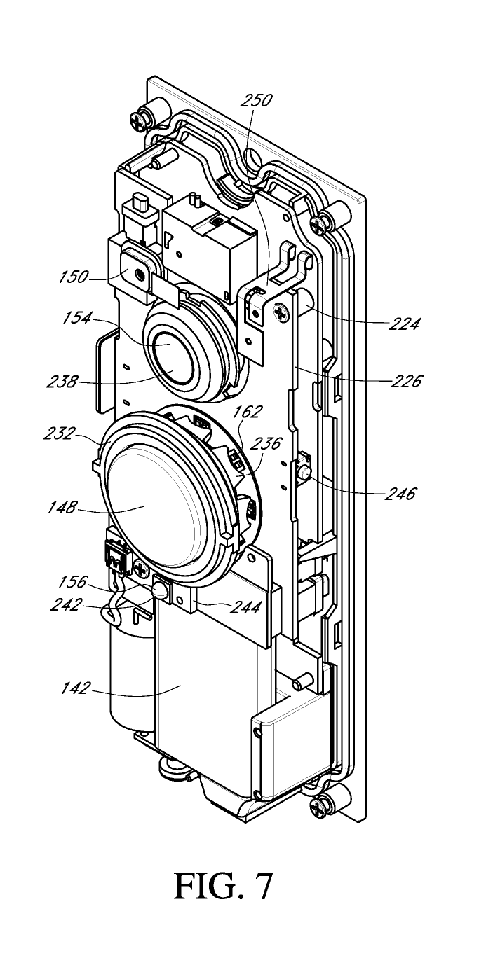

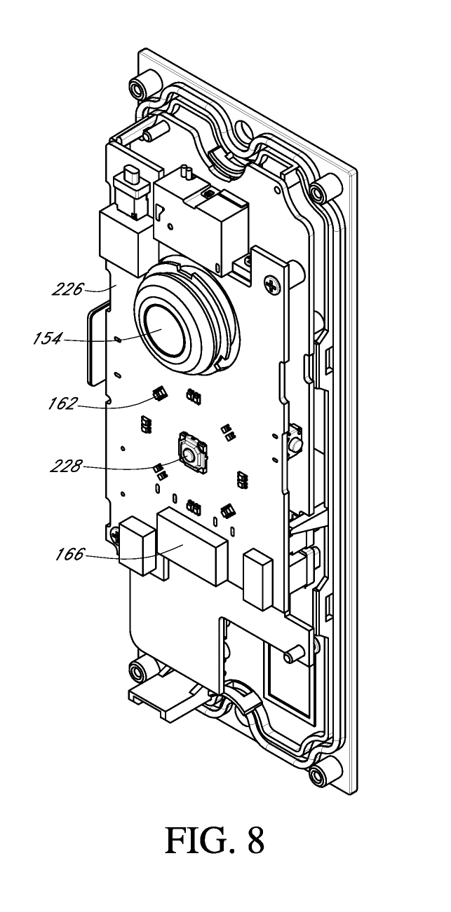

FIGS. 7-10 illustrate various internal components of the A/V recording and communication device 130. FIGS. 7-9 are front perspective views of the device 130 with the shell 184 and the enclosure 180 removed, while FIG. 10 is a right-side cross-sectional view of the device 130 taken through the line 10-10 in FIG. 4. With reference to FIGS. 7 and 8, the A/V recording and communication device 130 further comprises a main printed circuit board (PCB) 224 and a front PCB 226. With reference to FIG. 8, the front PCB 226 comprises a button actuator 228. With reference to FIGS. 7, 8, and 10, the front button 148 is located in front of the button actuator 228. The front button 148 includes a stem 230 (FIG. 10) that extends into the housing 178 to contact the button actuator 228. When the front button 148 is pressed, the stem 230 depresses the button actuator 228, thereby closing the electronic switch 166 (FIG. 8), as described below.

With reference to FIG. 8, the front PCB 226 further comprises the light indicators 162, which may illuminate when the front button 148 of the device 130 is pressed. In the illustrated embodiment, the light indicators 162 comprise light-emitting diodes (LEDs 162) that are surface mounted to the front surface of the front PCB 226 and are arranged in a circle around the button actuator 228. The present embodiments are not limited to the light indicators 162 being LEDs, and in alternative embodiments the light indicators 162 may comprise any other type of light-emitting device. The present embodiments are also not limited by the number of light indicators 162 shown in FIG. 8, nor by the pattern in which they are arranged.

With reference to FIG. 7, the device 130 further comprises a light pipe 232. The light pipe 232 is a transparent or translucent ring that encircles the front button 148. With reference to FIG. 4, the light pipe 232 resides in an annular space between the front button 148 and the central opening 206 in the shield 192, with a front surface 234 of the light pipe 232 being substantially flush with the front surface 210 of the shield 192. With reference to FIGS. 7 and 10, a rear portion of light pipe 232 includes a plurality of posts 236 whose positions correspond to the positions of the LEDs 162. When the LEDs 162 are illuminated, light is transmitted through the posts 236 and the body of the light pipe 232 so that the light is visible at the front surface 234 of the light pipe 232. The LEDs 162 and the light pipe 232 thus provide a ring of illumination around the front button 148. The light pipe 232 may comprise a plastic, for example, or any other suitable material capable of transmitting light.

The LEDs 162 and the light pipe 232 may function as visual indicators for a visitor and/or a user. For example, the LEDs 162 may illuminate upon activation or stay illuminated continuously. In one aspect, the LEDs 162 may change color to indicate that the front button 148 has been pressed. The LEDs 162 may also indicate that the battery 142 needs recharging, or that the battery 142 is currently being charged, or that charging of the battery 142 has been completed. The LEDs 162 may indicate that a connection to the user's wireless network is good, limited, poor, or not connected. The LEDs 162 may be used to guide the user through setup or installation steps using visual cues, potentially coupled with audio cues emitted from the speaker 152.

With further reference to FIG. 7, the A/V recording and communication device 130 further comprises a rechargeable battery 142. As described in further detail below, the A/V recording and communication device 130 is connected to an external power source 134 (FIG. 3), such as AC mains. The A/V recording and communication device 130 is primarily powered by the external power source 134, but may also draw power from the rechargeable battery 142 so as not to exceed a threshold amount of power from the external power source 134, to thereby avoid inadvertently sounding the signaling device 168. With reference to FIG. 3, the battery 142 is operatively connected to the power manager 140. As described below, the power manager 140 controls an amount of power drawn from the battery 142 to supplement the power drawn from the external AC power source 134 to power the A/V recording and communication device 130 when supplemental power is needed. The power manager 140 also controls recharging of the battery 142 using power drawn from the external power source 134. The battery 142 may comprise, for example, a lithium-ion battery, or any other type of rechargeable battery.

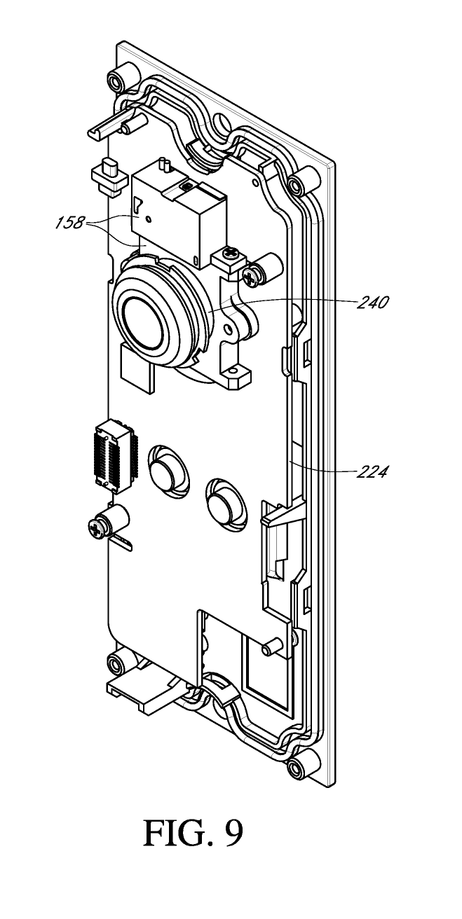

With further reference to FIG. 7, the A/V recording and communication device 130 further comprises the camera 154. The camera 154 is coupled to a front surface of the front PCB 226, and includes a lens 238 and an imaging processor 240 (FIG. 9). The camera lens 238 may be a lens capable of focusing light into the camera 154 so that clear images may be captured. The camera 154 may comprise, for example, a high definition (HD) video camera, such as one capable of capturing video images at an image display resolution of 720p or better. In certain of the present embodiments, the camera 154 may be used to detect motion within its field of view, as described below.

With further reference to FIG. 7, the A/V recording and communication device 130 further comprises an infrared (IR) light source 242. In the illustrated embodiment, the IR light source 242 comprises an IR light-emitting diode (LED) 242 coupled to an IR LED printed circuit board (PCB) 244. In alternative embodiments, the IR LED 242 may not comprise a separate PCB 244, and may, for example, be coupled to the front PCB 226.

With reference to FIGS. 7 and 10, the IR LED PCB 244 is located below the front button 148 (FIG. 7) and behind the lower portion 216 of the shield 192 (FIG. 10). As described above, the lower portion 216 of the shield 192 is transparent to IR light, but may be opaque with respect to light in the visible spectrum. In alternative embodiments of the IR LED PCB 244, the IR LED PCB 244 may include more than one IR LED 242. For example, the IR LED PCB 244 may include three IR LEDs 242, or any other number of IR LEDs 242. In embodiments including more than one IR LED 242, the size of the third opening in the cover may be increased to accommodate the larger size of the IR LED PCB 244.

The IR LED 242 may be triggered to activate when a low level of ambient light is detected. When activated, IR light emitted from the IR LED 242 illuminates the camera 154′s field of view. The camera 154, which may be configured to detect IR light, may then capture the IR light emitted by the IR LED 242 as it reflects off objects within the camera 154′s field of view, so that the A/V recording and communication device 130 can clearly capture images at night (may be referred to as “night vision”).

With reference to FIG. 9, the A/V recording and communication device 130 further comprises an IR cut filter 158. The IR cut filter 158 is a mechanical shutter that can be selectively positioned between the lens 238 and the image sensor of the camera 154. During daylight hours, or whenever there is a sufficient amount of ambient light, the IR cut filter 158 is positioned between the lens 238 and the image sensor to filter out IR light so that it does not distort the colors of images as the human eye sees them. During nighttime hours, or whenever there is little to no ambient light, the IR cut filter 158 is withdrawn from the space between the lens 238 and the image sensor, so that the camera 154 is sensitive to IR light (“night vision”). In some embodiments, the camera 154 acts as a light detector for use in controlling the current state of the IR cut filter 158 and turning the IR LED 242 on and off. Using the camera 154 as a light detector is facilitated in some embodiments by the fact that the A/V recording and communication device 130 is powered by a connection to AC mains, and the camera 154, therefore, is always powered on. In other embodiments, however, the A/V recording and communication device 130 may include a light sensor separate from the camera 154 for use in controlling the IR cut filter 158 and the IR LED 242.

With reference back to FIG. 6, the A/V recording and communication device 130 further comprises a reset button 170. The reset button 170 contacts a reset button actuator 246 (FIG. 8) coupled to the front PCB 226. When the reset button 170 is pressed, it may contact the reset button actuator 246, which may trigger the erasing of any data stored at the non-volatile memory 174 and/or at the memory 172 (FIG. 3), and/or may trigger a reboot of the processor 160. In some embodiments, the reset button 170 may also be used in a process to activate the A/V recording and communication device 130, as described below.

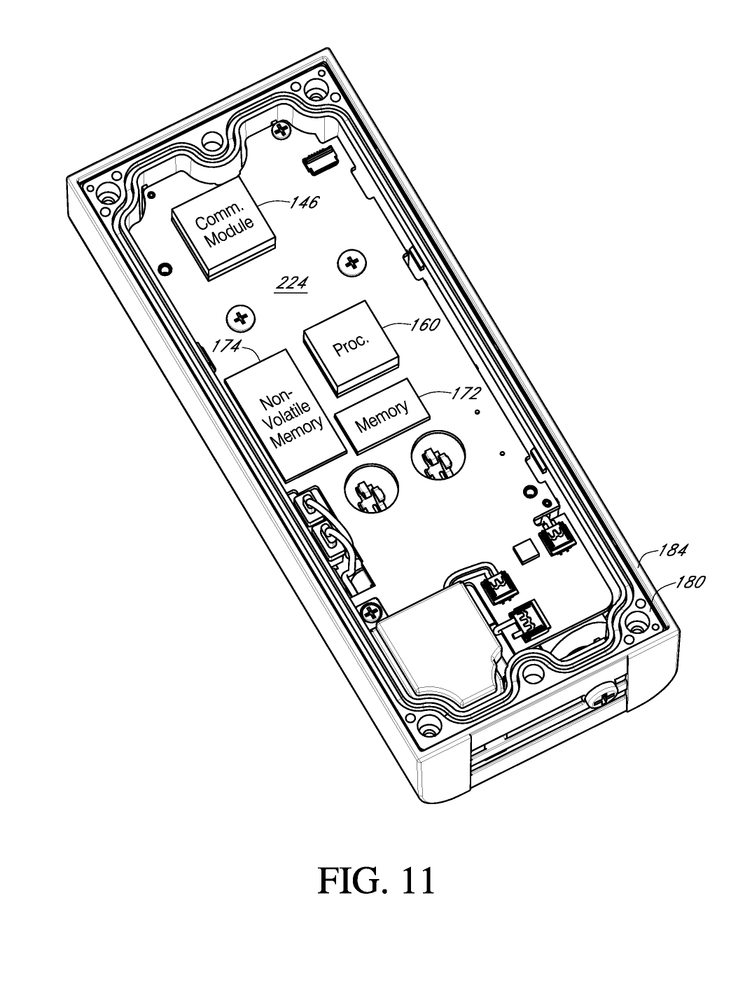

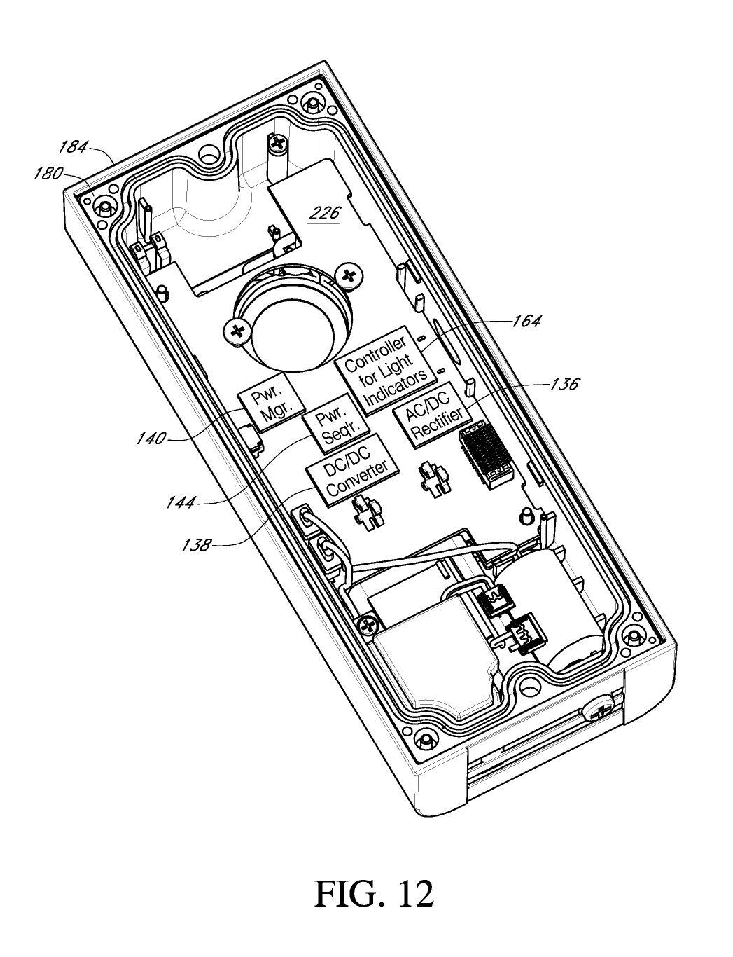

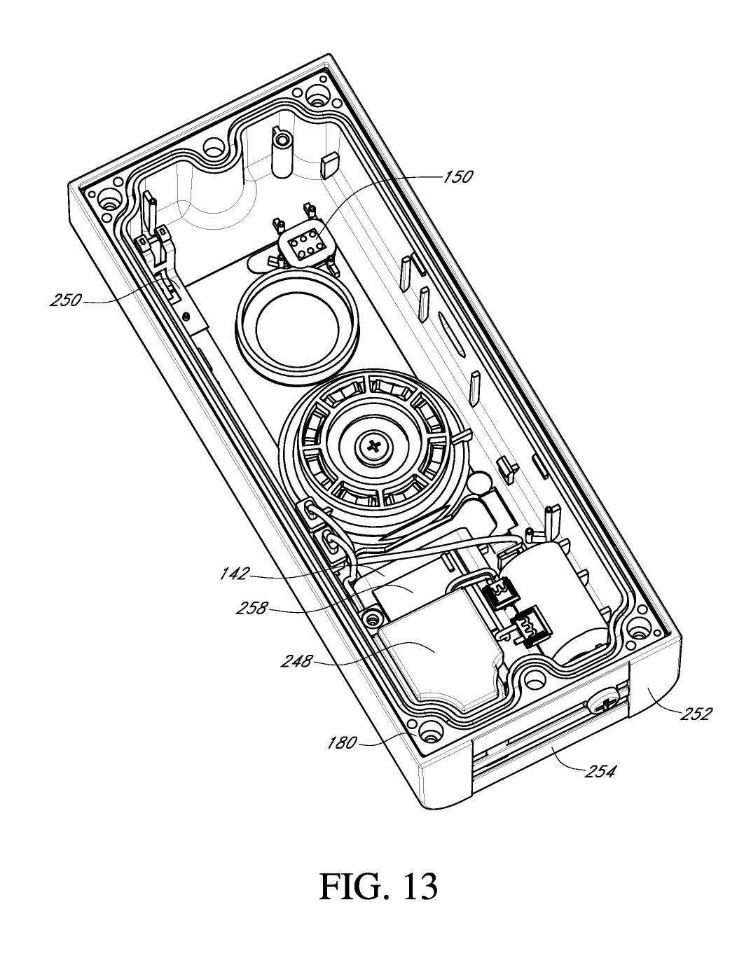

FIGS. 11-13 further illustrate internal components of the A/V recording and communication device 130. FIGS. 11-13 are rear perspective views of the device 130 with the back plate 182 and additional components removed. For example, in FIG. 11 the back plate 182 is removed, while in FIG. 12 the back plate 182 and the main PCB 224 are removed, and in FIG. 13 the back plate 182, the main PCB 224, and the front PCB 226 are removed. With reference to FIG. 11, several components are coupled to the rear surface of the main PCB 224, including the communication module 146, the processor 160, memory 172, and non-volatile memory 174. The functions of each of these components are described below. With reference to FIG. 12, several components are coupled to the rear surface of the front PCB 226, including the power manager 140, the power sequencer 144, the AC/DC rectifier 136, the DC/DC converter 138, and the controller 164 for the light indicators 162. The functions of each of these components are also described below. With reference to FIG. 13, several components are visible within the enclosure 180, including the microphone 150, a speaker chamber 248 (in which the speaker 152 is located), and an antenna 250 for the communication module 146. The functions of each of these components are also described below.

With reference to FIG. 7, the antenna 250 is coupled to the front surface of the main PCB 224 and operatively connected to the communication module 146, which is coupled to the rear surface of the main PCB 224 (FIG. 11). The microphone 150, which may also be coupled to the front surface of the main PCB 224, is located near the opening 218 (FIG. 4) in the upper portion 214 of the shield 192 so that sounds emanating from the area around the A/V recording and communication device 130 can pass through the opening 218 and be detected by the microphone 150. With reference to FIG. 13, the speaker chamber 248 is located near the bottom of the enclosure 180. The speaker chamber 248 comprises a hollow enclosure in which the speaker 152 is located. The hollow speaker chamber 248 amplifies the sounds made by the speaker 152 so that they can be better heard by a visitor in the area near the A/V recording and communication device 130. With reference to FIGS. 5 and 13, the lower surface 252 of the shell 184 and the lower surface (not shown) of the enclosure 180 may include an acoustical opening 254 through which the sounds made by the speaker 152 can pass so that they can be better heard by a visitor in the area near the A/V recording and communication device 130. In the illustrated embodiment, the acoustical opening 254 is shaped generally as a rectangle having a length extending substantially across the lower surface 252 of the shell 184 (and also the enclosure 180). The illustrated shape is, however, just one example. With reference to FIG. 5, the lower surface 252 of the shell 184 may further include an opening 256 for receiving a security screw (not shown). The security screw may extend through the opening 256 and into a similarly located opening in the enclosure 180 to secure the shell 184 to the enclosure 180. If the device 130 is mounted to a mounting bracket (not shown), the security screw may also maintain the device 130 on the mounting bracket.

With reference to FIG. 13, the A/V recording and communication device 130 may further include a battery heater 258. The present A/V recording and communication device 130 is configured for outdoor use, including in cold climates. Cold temperatures, however, can cause negative performance issues for rechargeable batteries, such as reduced energy capacity, increased internal resistance, reduced ability to charge without damage, and reduced ability to supply load current. The battery heater 258 helps to keep the rechargeable battery 142 warm in order to reduce or eliminate the foregoing negative performance issues. In the illustrated embodiment, the battery heater 258 comprises a substantially flat, thin sheet abutting a side surface of the rechargeable battery 142. The battery heater 258 may comprise, for example, an electrically resistive heating element that produces heat when electrical current is passed through it. The battery heater 258 may thus be operatively coupled to the power manager 140 and/or the power sequencer 144 (FIG. 12). In some embodiments, the rechargeable battery 142 may include a thermally sensitive resistor (“thermistor,” not shown) operatively connected to the processor 160 so that the battery 142's temperature can be monitored and the amount of power supplied to the battery heater 258 can be adaptively controlled to keep the rechargeable battery 142 within a desired temperature range.

As discussed above, the present disclosure provides numerous examples of methods and systems including A/V recording and communication doorbells, but the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and functionality of the device 130, but without the front button 148, the button actuator 228, and/or the light pipe 232.

The present disclosure also provides numerous examples of methods and systems including A/V recording and communication devices that are powered by a connection to AC mains, but the present embodiments are equally applicable for A/V recording and communication devices that are battery powered. For example, the present embodiments may include an A/V recording and communication device such as those described in US Patent Application Publication Nos. 2015/0022620 (application Ser. No. 14/499,828) and 2015/0022618 (application Ser. No. 14/334,922), both of which are incorporated herein by reference in their entireties as if fully set forth.

One aspect of the present embodiments includes the realization that audio/video (A/V) recording and communication devices, such as doorbells, can make neighborhoods safer. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

In light of the foregoing aspects of A/V recording and communication devices, it would be advantageous to increase the prevalence of A/V recording and communication devices in communities. One way of increasing the prevalence of A/V recording and communication devices in communities would be to give them away, free of charge, to homeowners, renters, landlords, etc. There is a cost, though, associated with producing A/V recording and communication devices. Thus, manufacturing such devices and simply giving them away is not a sustainable business model.

The present embodiments solve the foregoing problem by transferring, free of charge, A/V recording and communication devices to other parties for installation at structures such as homes. The parties to whom the devices are distributed may be people and/or businesses in the construction trade, such as homebuilders, contractors, and/or subcontractors. These parties/persons may then install the devices at structures that they are building, renovating, remodeling, etc. When the devices are distributed and/or installed, they may be in a pre-activation mode in which the devices have limited functionality. For example, if the devices are doorbells, they may be capable of functioning like a traditional doorbell whereby they may sound a signaling device (such as a bell or buzzer) when the front button on the doorbell is pressed. The camera and/or the recording capabilities of the doorbells, however, may be disabled in the pre-activation mode. The homeowner (or renter or other occupant) may subsequently desire to activate the A/V recording and communication device. During the activation process, the homeowner may be required to submit a payment for the A/V recording and communication device. The manufacturer of the device is thus compensated for the device, and the prevalence of such devices in communities is increased because it may be more likely that a person will activate a device that is already installed in his or her home than it would be for that same person to purchase, install, and activate an A/V recording and communication device on his or her own. In at least some of the present embodiments, even if the A/V recording and communication device is never activated (e.g. the homeowner never submits a payment for the A/V recording and communication device) the A/V recording and communication device may still function indefinitely in the pre-activation mode (e.g. the A/V recording and communication device may function like a traditional doorbell and sound a signaling device).

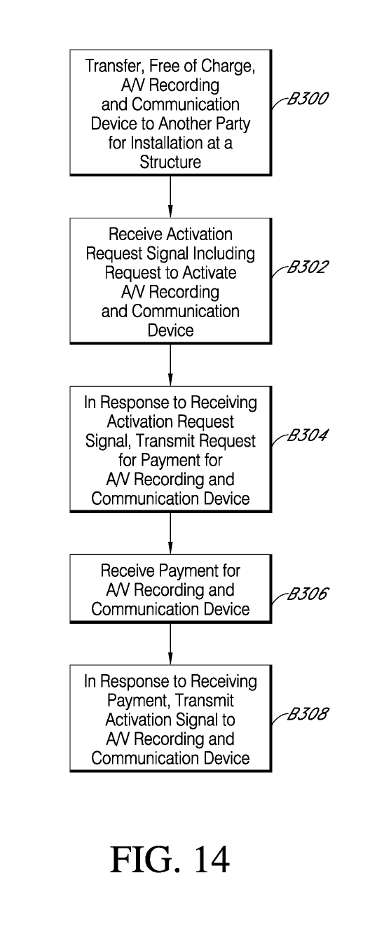

FIGS. 14-23 illustrate example embodiments of methods relating to A/V recording and communication devices according to various aspects of the present disclosure. For example, with reference to FIG. 14, at block B300, an example method comprises transferring, free of charge, an A/V recording and communication device to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. In the pre-activation mode, the A/V recording and communication device may have limited functionality. For example, if the A/V recording and communication device is a doorbell, such as the A/V recording and communication device 130 of FIGS. 3-13, the device 130 in the pre-activation mode may be capable of functioning like a traditional doorbell. Thus, for example, the device 130 may be connected to a signaling device 168 (such as a bell or buzzer) and may sound the signaling device 168 when the front button 148 is pressed. However, the camera 154 may be disabled in the pre-activation mode, such that the device 130 cannot record video images. In other embodiments, in the pre-activation mode the camera 154 may not be disabled, but its functionality may be inaccessible to the user. For example, the camera 154 may be able to record video images, and the recorded video images may be transmitted by the wireless communication module 146 to one or more network devices (such as the server 118 and/or the backend API 120), but the user (such as the homeowner) may not be able to view the recorded video images.

At block B302, the example method further comprises receiving an activation request signal including a request to activate the A/V recording and communication device. With reference to FIG. 1, the activation request signal may be received by a network device, such as the server 118 and/or the backend API 120. In some embodiments, the activation request signal may be received from the A/V recording and communication device 100/130, and in other embodiments the activation request signal may be received from the client device 114. For example, a user may download an application to his or her client device 114, which may be, for example, a smartphone, a tablet computer, or another computing device. The application may facilitate the process of activating the A/V recording and communication device by providing user prompts to provide certain information and/or to perform certain steps. With reference to FIG. 1, during the process of activating the A/V recording and communication device 100, the client device 114 may be connected to the user's wireless network 110 and/or to a network broadcast by the A/V recording and communication device 100.

At block B304, the example method further comprises, in response to receiving the activation request signal, transmitting a request for payment for the A/V recording and communication device. The request for payment for the A/V recording and communication device may be transmitted to the client device 114, for example, and/or to the A/V recording and communication device. At block B306, the example method further comprises receiving the payment for the A/V recording and communication device. The payment may be received from the client device 114, for example. At block B308, the example method further comprises, in response to receiving the payment, transmitting an activation signal to the A/V recording and communication device. The activation signal may activate or enable any components and/or features of the A/V recording and communication device that were disabled in the pre-activation mode.

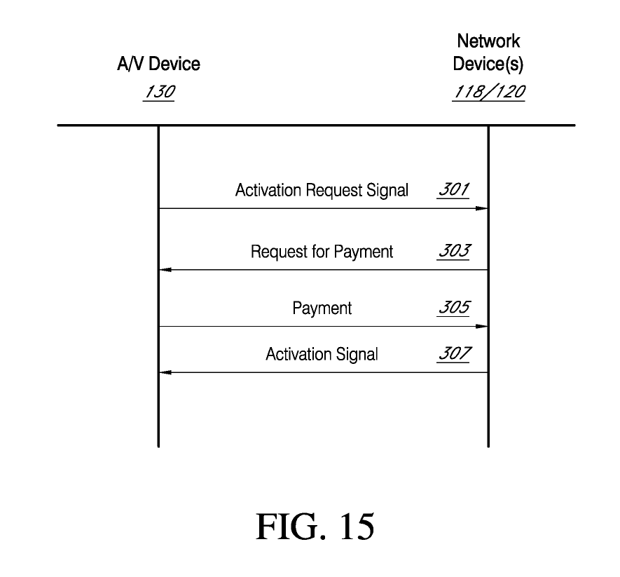

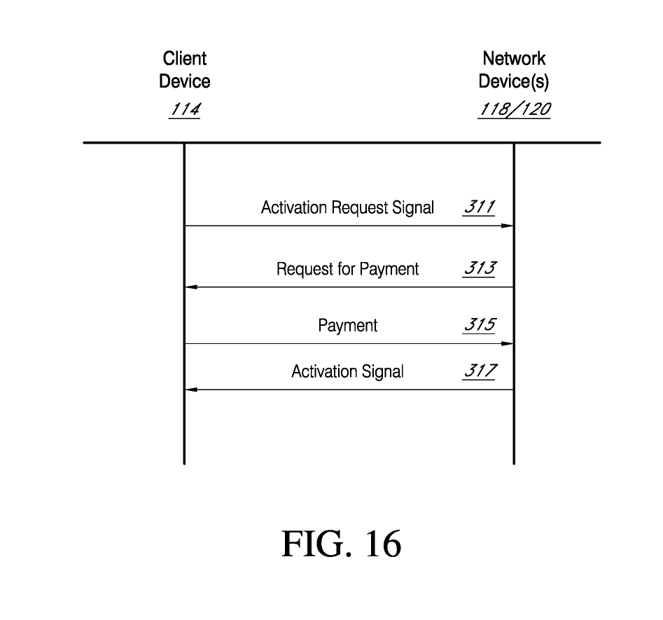

FIGS. 15 and 16 are sequence diagrams illustrating processes for activating an A/V recording and communication device according to various aspects of the present disclosure. As described above with reference to FIG. 14, an activation process may comprise receiving an activation request signal, transmitting a request for payment, receiving the payment, and transmitting an activation signal. With reference to FIG. 15, these aspects may be performed in connection with the A/V recording and communication device 130 and one or more network devices, such as the server 118 and/or the backend API 120. For example, the activation request signal 301 may be received by the network device(s) 118/120 from the A/V recording and communication device 130, the request for payment 303 may be transmitted by the network device(s) 118/120 to the A/V recording and communication device 130, the payment 305 may be received by the network device(s) 118/120 from the A/V recording and communication device 130, and the activation signal 307 may be transmitted by the network device(s) 118/120 to the A/V recording and communication device 130.

Alternatively, with reference to FIG. 16, the foregoing aspects may be performed in connection with the client device 114 and one or more network devices, such as the server 118 and/or the backend API 120. For example, the activation request signal 311 may be received by the network device(s) 118/120 from the client device 114, the request for payment 313 may be transmitted by the network device(s) 118/120 to the client device 114, the payment 315 may be received by the network device(s) 118/120 from the client device 114, and the activation signal 317 may be transmitted by the network device(s) 118/120 to the client device 114.

In other embodiments, the foregoing aspects may be performed in connection with a combination of the client device 114, the A/V recording and communication device 130, and one or more network devices, such as the server 118 and/or the backend API 120. For example, the activation request signal 311 may be received by the network device(s) 118/120 from the client device 114, the request for payment 313 may be transmitted by the network device(s) 118/120 to the client device 114, the payment 315 may be received by the network device(s) 118/120 from the client device 114, and the activation signal 307 may be transmitted by the network device(s) 118/120 to the A/V recording and communication device 130.

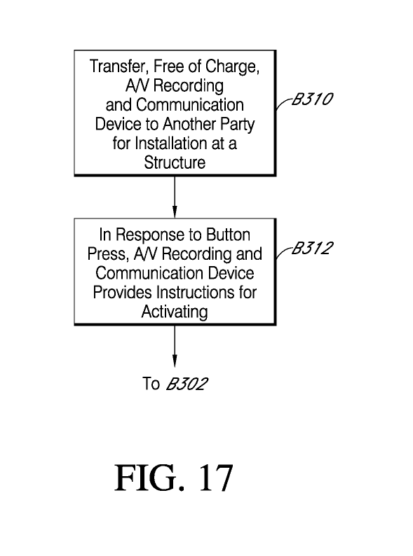

As described above, the A/V recording and communication device may include a button that may be used in a process for activating the A/V recording and communication device. For example, with reference to FIG. 6, the A/V recording and communication device 130 includes a button 170. In some embodiments, and with reference to FIG. 17, when the button 170 is pressed, the A/V recording and communication device may provide instructions for activating the A/V recording and communication device, as shown at block B312. In one example, the instructions may be audible and may be provided via the speaker 152 of the A/V recording and communication device 130. In another example, the instructions may be written and may be provided via the application executing on the client device 114. In some embodiments, the instructions may include information about a discount offered on the cost of the A/V recording and communication device. In some embodiments, the information may indicate that the discount offer is a limited-time discount offer. With reference to FIG. 17, after the instructions are provided at block B312, in some embodiments the process may continue at block B302 et seq. of FIG. 14. In other embodiments, the process may not continue at block B302 et seq. of FIG. 14. The process of FIG. 17 may also comprise transferring, free of charge, an A/V recording and communication device to another party for installation at a structure, as shown at block B310.

In some embodiments, prior to the A/V recording and communication device being activated, the wireless communication module of the A/V recording and communication device may operate in a wireless access point mode and broadcast a wireless network. If a client device connects to the wireless network broadcast by the wireless communication module, then in response to the client device connecting to the wireless network broadcast by the wireless communication module of the A/V recording and communication device, some embodiments may provide instructions for activating the A/V recording and communication device. The instructions may be provided via the A/V recording and communication device, such as via the speaker 152, and/or via the client device 114, such as via an application executing on the client device 114.

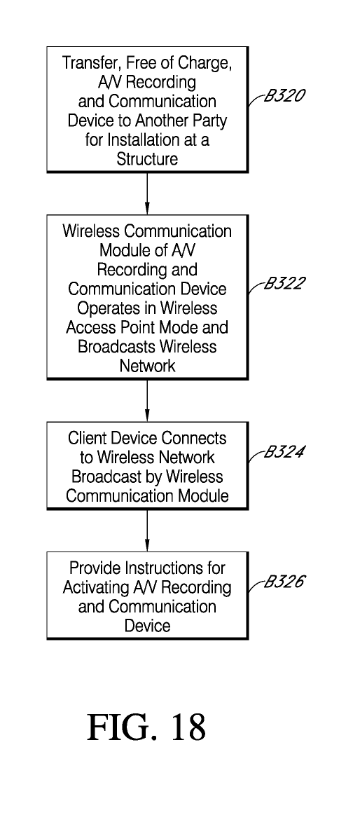

For example, FIG. 18 illustrates a process for transferring and activating an A/V recording and communication device according to various aspects of the present disclosure. At block B320, an example method comprises transferring, free of charge, an A/V recording and communication device to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. At block B322, the wireless communication module 146 of the A/V recording and communication device 130 may operate in a wireless access point mode and broadcast a wireless network. At block B324, a client device 114 may connect to the wireless network broadcast by the wireless communication module 146. At block B326, instructions may be provided for activating the A/V recording and communication device 130.

When the A/V recording and communication device is operating in a wireless access point mode and broadcasting a wireless network, the wireless network may have a network name. In some embodiments, the network name may provide information about purchasing and/or activating the A/V recording and communication device. For example, the network name may indicate a discount offer on the cost of the A/V recording and communication device. The discount offer may coincide with a holiday, and the network name may correspond to the name of the holiday in conjunction with which the discount is offered. For example, on or around Mother's Day the network name may indicate a Mother's Day discount offer. An example network name may be “Mother's Day Special Offer on Activation of this A/V Recording and Communication Device.”

In some embodiments, the name of the wireless network may be changed remotely, such as via a signal sent over a cellular network. With reference to FIG. 3, the communication module 146 of the A/V recording and communication device 130 may be capable of sending and/or receiving signals sent over a cellular network even before the A/V recording and communication device 130 has been activated. Thus, information may be sent to the A/V recording and communication device 130 (and/or received from the A/V recording and communication device 130) before the A/V recording and communication device 130 has been activated.

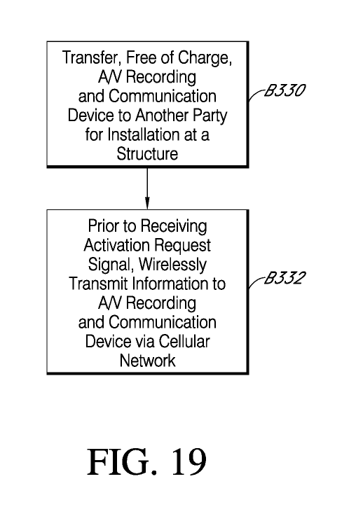

For example, with reference to FIG. 19, at block B330 an A/V recording and communication device may be transferred, free of charge, to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. At block B332, prior to receiving an activation request signal, information may be wirelessly transmitted to the A/V recording and communication device 130 via a cellular network. Thus, in some embodiments, the name of the wireless network broadcast by the communication module 146 may be changed remotely from a first wireless network name to a second wireless network name. One or both of the first wireless network name and the second wireless network name may indicate a discount offer on the cost of the A/V recording and communication device, and the discount offer may indicate that the discount is being offered for a limited time, such as in conjunction with a holiday.

In some alternative embodiments, prior to the A/V recording and communication device being activated, the wireless communication module of the A/V recording and communication device may operate in a discoverable mode according to a short-range wireless protocol. For example, the short-range wireless protocol may comprise Bluetooth or another protocol. If a client device connects to the wireless communication module when it is operating in a discoverable mode according to a short-range wireless protocol, then in response to the client device connecting to the wireless communication module of the A/V recording and communication device, some embodiments may provide instructions for activating the A/V recording and communication device. The instructions may be provided via the A/V recording and communication device, such as via the speaker 152, and/or via the client device 114, such as via an application executing on the client device 114.

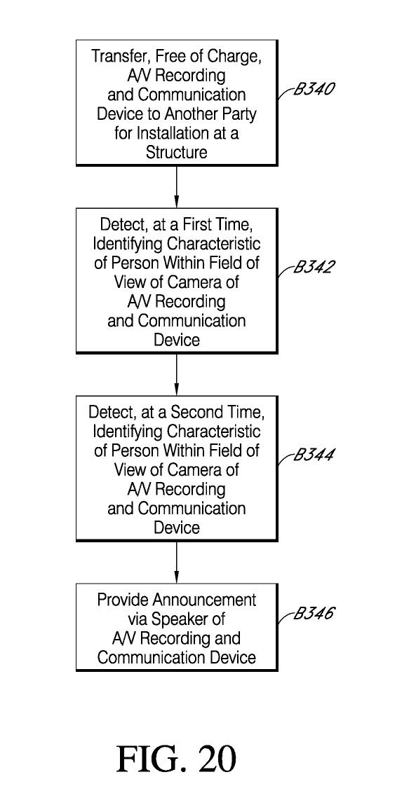

FIG. 20 illustrates another process for transferring and activating an A/V recording and communication device according to various aspects of the present disclosure. At block B340 an A/V recording and communication device may be transferred, free of charge, to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. At block B342, an identifying characteristic of a person is detected, at a first time, within a field of view of the camera. At block B344, the identifying characteristic of the person is again detected, at a second time after the first time, within the field of view of the camera. At block B346, in response to the detecting, at the second time after the first time, the identifying characteristic of the person within the field of view of the camera, the A/V recording and communication device provides an announcement via a speaker of the A/V recording and communication device. For example, the announcement may encourage the person to activate the A/V recording and communication device.

In the process of FIG. 20, and in related processes, the detected identifying characteristic of the person may be any characteristic, such as one or more facial characteristics, the color and/or type of clothing worn by the person, whether or not the person is wearing glasses or any type of headwear, etc. The identifying characteristics may be detected from video images captured by the camera 154. Video images may be analyzed locally at the A/V recording and communication device 130, such as by the processor 160. Alternatively, or in addition, video images may be transmitted to one or more network devices, such as the server 118 and/or the backend API 120, to be analyzed. A process of analyzing video images may comprise comparing information from video images captured at a first time with information from video images captured at a second time to determine the likelihood that the person depicted in the video images captured at the first time is the same person depicted in the video images captured at the second time. If it is likely that the person depicted in the video images captured at the first time is the same person depicted in the video images captured at the second time, then the A/V recording and communication device may provide the announcement described above. When it is likely that the person depicted in the video images captured at the first time is the same person depicted in the video images captured at the second time, then that person may be the homeowner (or renter or other occupant), and therefore may be receptive to the announcement from the A/V recording and communication device, which announcement may be designed to encourage the person to activate the A/V recording and communication device.

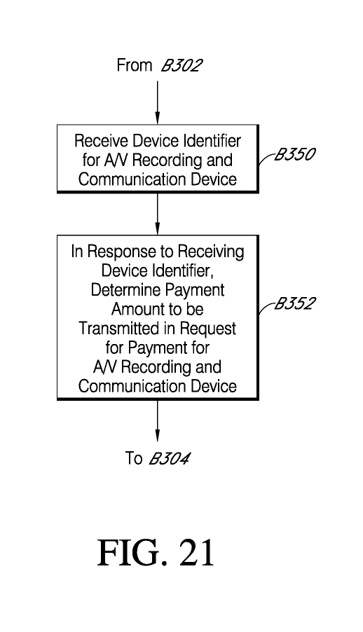

FIG. 21 illustrates another process for transferring and activating an A/V recording and communication device according to various aspects of the present disclosure. At block B350, a device identifier corresponding to the A/V recording and communication device may be received prior to transmitting the request for payment for the A/V recording and communication device. At block B352, in response to receiving the device identifier corresponding to the A/V recording and communication device, the process may determine a payment amount to be transmitted in the request for payment for the A/V recording and communication device. In some embodiments, the payment amount requested may be based on the received device identifier corresponding to the A/V recording and communication device.

For example, the received device identifier may be used to determine where the A/V recording and communication device was installed and/or who installed the A/V recording and communication device, and that information may be used to determine the payment amount. In some embodiments, the process illustrated in FIG. 21 may occur together with the process illustrated in FIG. 14, with block B350 occurring after block B302 and block B304 occurring after block B352.

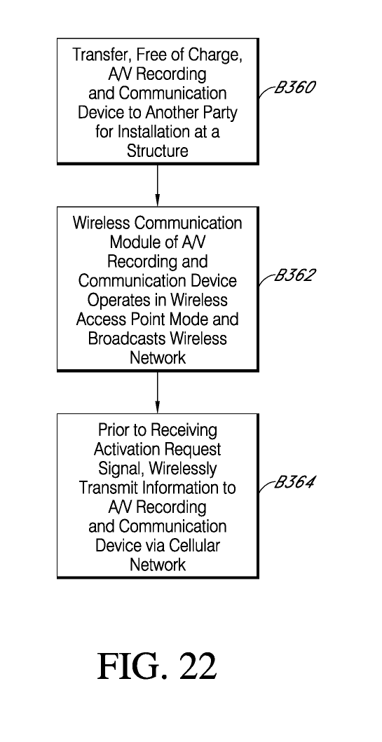

FIG. 22 illustrates another process for transferring and activating an A/V recording and communication device according to various aspects of the present disclosure. At block B360, the process comprises transferring, free of charge, an A/V recording and communication device to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. At block B362, the process further comprises the wireless communication module of the A/V recording and communication device operating in a wireless access point mode and broadcasting a wireless network. At block B362, the process further comprises wirelessly transmitting information to the A/V recording and communication device via a cellular network.

For example, with reference to FIG. 1, the A/V recording and communication device 100/130 may connect directly to the network 112 (without connecting to the user's wireless network 110) even before the A/V recording and communication device 100/130 has been activated. As described above, the network 112 may include a cellular network. To enable connection directly to the network 112, the communication module 146 of the A/V recording and communication device 130 may be capable of sending and/or receiving signals sent over a cellular network. Thus, information may be sent to the A/V recording and communication device 130 (and/or received from the A/V recording and communication device 130) even before the A/V recording and communication device 130 has been activated.

In some embodiments, the information wirelessly transmitted to the A/V recording and communication device via the cellular network may include information about an event that occurred within a defined radius of a location of the A/V recording and communication device. For example, the A/V recording and communication device (first device) may be located in or around the same community as another A/V recording and communication device (second device). The second A/V recording and communication device may be in an activated mode (e.g. not in a pre-activation mode in which one or more components is disabled or inaccessible to the user). The camera of the second A/V recording and communication device may record video images of an event, such as a crime, that may be of interest to the homeowner (or renter or other occupant) at the location of the first A/V recording and communication device, which may still be in a pre-activation mode. Thus, information about the event captured by the second A/V recording and communication device may be sent to the first A/V recording and communication device. The information may comprise, for example, an announcement played through the speaker 152 of the first A/V recording and communication device 130. The announcement may provide instructions on how to view the video images recorded by the second A/V recording and communication device, such as by accessing a web portal (e.g. an Internet website), or by downloading an application to the homeowner's (or renter's or other occupant's) client device. Further examples of sharing video recorded by A/V recording and communication devices are described in U.S. patent application Ser. No. 62/300,547, filed on Feb. 26, 2016, which is incorporated herein by reference in its entirety as if fully set forth.

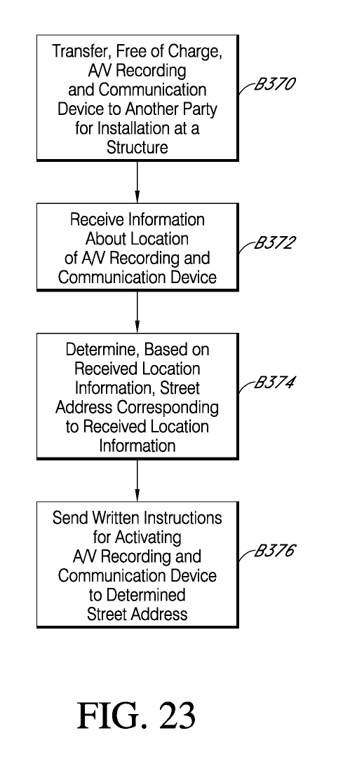

FIG. 23 illustrates another process for transferring and activating an A/V recording and communication device according to various aspects of the present disclosure. At block B370, the process comprises transferring, free of charge, an A/V recording and communication device to another party for installation at a structure. The A/V recording and communication device is configured to be secured to the structure, and may include a processor, a camera, and a wireless communication module (and may include other components). The A/V recording and communication device may be in a pre-activation mode when it is transferred and/or installed. At block B372, the process further comprises receiving information about a location of the A/V recording and communication device. In one example, the received location information may be received from the A/V recording and communication device via a cellular network. In this example, the A/V recording and communication device may “phone home” to provide its location information to a backend server and/or API, such as the server 118 and/or the backend API 120 (FIG. 1). The location information provided by the A/V recording and communication device may comprise, for example, GPS (Global Positioning System) coordinates. In such embodiments, the A/V recording and communication device may include a GPS transceiver. In other examples, the location information provided by the A/V recording and communication device may comprise one or more images captured by the camera 154, one or more sounds captured by the microphone 150, and/or environmental information such as temperature, humidity, atmospheric pressure, etc. In embodiments in which the A/V recording and communication device provides environmental information, the A/V recording and communication device may comprise one or more environmental sensors, such as a thermometer, a hygrometer, a barometer, etc.

At block B374, the process further comprises determining, based on the received location information, a street address corresponding to the received location information. For example, the street address may be determined by matching GPS coordinates in the received location information to the nearest known street address. At block B376, the process further comprises sending, to the determined street address, written instructions for activating the A/V recording and communication device. For example, the written instructions may be sent via standard mail, or other delivery service, to the determined street address.

In another example embodiment, the received location information may be received from another party, such as the homebuilder (or contractor, subcontractor, etc.) who installed the A/V recording and communication device. For example, the homebuilder (or contractor, subcontractor, etc.) may enter location information for one or more A/V recording and communication devices via a web portal (e.g. an Internet website). The location information provided by the homebuilder may be the street address where the A/V recording and communication device was installed. In such embodiments, the aspect of determining, based on the received location information, a street address corresponding to the received location information (block B374) may comprise simply receiving (or retrieving at a later time) the location information. The location information provided by the homebuilder may be received at a backend server and/or API, such as the server 118 and/or the backend API 120 (FIG. 1).

As described above, the present embodiments advantageously facilitate the installation and activation of A/V recording and communication devices by transferring, free of charge, such devices to other parties for installation at structures such as homes. These parties/persons, such as homebuilders, contractors, and/or subcontractors, may then install the devices at structures that they are building, renovating, remodeling, etc. When the devices are distributed and/or installed, they may be in a pre-activation mode in which the devices have limited functionality. For example, if the devices are doorbells, they may be capable of functioning like a traditional doorbell whereby they may sound a signaling device (such as a bell or buzzer) when the front button on the doorbell is pressed. The camera and/or the recording capabilities of the doorbells, however, may be disabled in the pre-activation mode. The homeowner (or renter or other occupant) may subsequently desire to activate the A/V recording and communication device. During the activation process, the homeowner may be required to submit a payment for the A/V recording and communication device. The manufacturer of the device is thus compensated for the device, and the prevalence of such devices in communities is increased because it may be more likely that a person will activate a device that is already installed in his or her home than it would be for that same person to purchase, install, and activate an A/V recording and communication device on his or her own. In at least some of the present embodiments, even if the A/V recording and communication device is never activated (e.g. the homeowner never submits a payment for the A/V recording and communication device) the A/V recording and communication device may still function indefinitely in the pre-activation mode (e.g. the A/V recording and communication device may function like a traditional doorbell and sound a signaling device).

While not explicitly stated above, it should be understood that, in some embodiments, any of the processes illustrated in FIGS. 17-23 may occur together with the process illustrated in FIG. 14. Further, while not explicitly stated above, it should be understood that some aspects of the processes described herein may be performed after the A/V recording and communication device has been installed at a structure. For example, in the process of FIG. 14, blocks B302-B308 may be performed after the A/V recording and communication device has been installed at a structure. In the process of FIG. 17, block B312 may be performed after the A/V recording and communication device has been installed at a structure. In the process of FIG. 18, blocks B322-B326 may be performed after the A/V recording and communication device has been installed at a structure. In the process of FIG. 19, block B332 may be performed after the A/V recording and communication device has been installed at a structure. In the process of FIG. 20, blocks B342-B346 may be performed after the A/V recording and communication device has been installed at a structure. In the process of FIG. 21, blocks B350-B352 may be performed after the A/V recording and communication device has been installed at a structure. In the process of FIG. 22, blocks B362-B364 may be performed after the A/V recording and communication device has been installed at a structure. In the process of FIG. 23, blocks B372-B376 may be performed after the A/V recording and communication device has been installed at a structure.

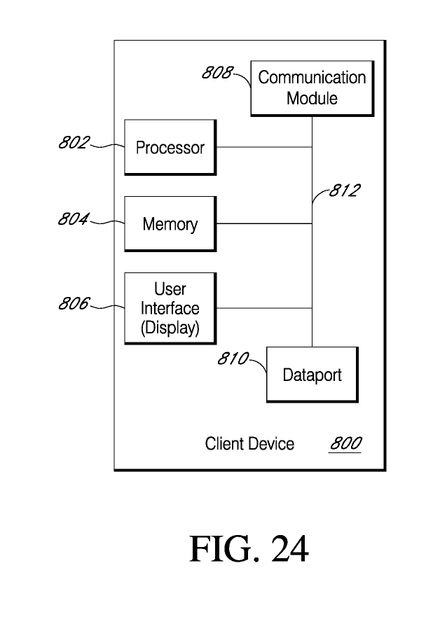

FIG. 24 is a functional block diagram of a client device 800 on which the present embodiments may be implemented according to various aspects of the present disclosure. The user's client device 114 described with reference to FIG. 1 may include some or all of the components and/or functionality of the client device 800. The client device 800 may comprise, for example, a smartphone.

With reference to FIG. 24, the client device 800 includes a processor 802, a memory 804, a user interface 806, a communication module 808, and a dataport 810. These components are communicatively coupled together by an interconnect bus 812. The processor 802 may include any processor used in smartphones and/or portable computing devices, such as an ARM processor (a processor based on the RISC (reduced instruction set computer) architecture developed by Advanced RISC Machines (ARM).). In some embodiments, the processor 802 may include one or more other processors, such as one or more conventional microprocessors, and/or one or more supplementary co-processors, such as math co-processors.

The memory 804 may include both operating memory, such as random access memory (RAM), as well as data storage, such as read-only memory (ROM), hard drives, flash memory, or any other suitable memory/storage element. The memory 804 may include removable memory elements, such as a CompactFlash card, a MultiMediaCard (MMC), and/or a Secure Digital (SD) card. In some embodiments, the memory 804 may comprise a combination of magnetic, optical, and/or semiconductor memory, and may include, for example, RAM, ROM, flash drive, and/or a hard disk or drive. The processor 802 and the memory 804 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 802 may be connected to the memory 804 via the dataport 810.

The user interface 806 may include any user interface or presentation elements suitable for a smartphone and/or a portable computing device, such as a keypad, a display screen, a touchscreen, a microphone, and a speaker. The communication module 808 is configured to handle communication links between the client device 800 and other, external devices or receivers, and to route incoming/outgoing data appropriately. For example, inbound data from the dataport 810 may be routed through the communication module 808 before being directed to the processor 802, and outbound data from the processor 802 may be routed through the communication module 808 before being directed to the dataport 810. The communication module 808 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 810 may be any type of connector used for physically interfacing with a smartphone and/or a portable computing device, such as a mini-USB port or an IPHONE®/IPOD® 30-pin connector or LIGHTNING® connector. In other embodiments, the dataport 810 may include multiple communication channels for simultaneous communication with, for example, other processors, servers, and/or client terminals.

The memory 804 may store instructions for communicating with other systems, such as a computer. The memory 804 may store, for example, a program (e.g., computer program code) adapted to direct the processor 802 in accordance with the present embodiments. The instructions also may include program elements, such as an operating system. While execution of sequences of instructions in the program causes the processor 802 to perform the process steps described herein, hard-wired circuitry may be used in place of, or in combination with, software/firmware instructions for implementation of the processes of the present embodiments. Thus, the present embodiments are not limited to any specific combination of hardware and software.

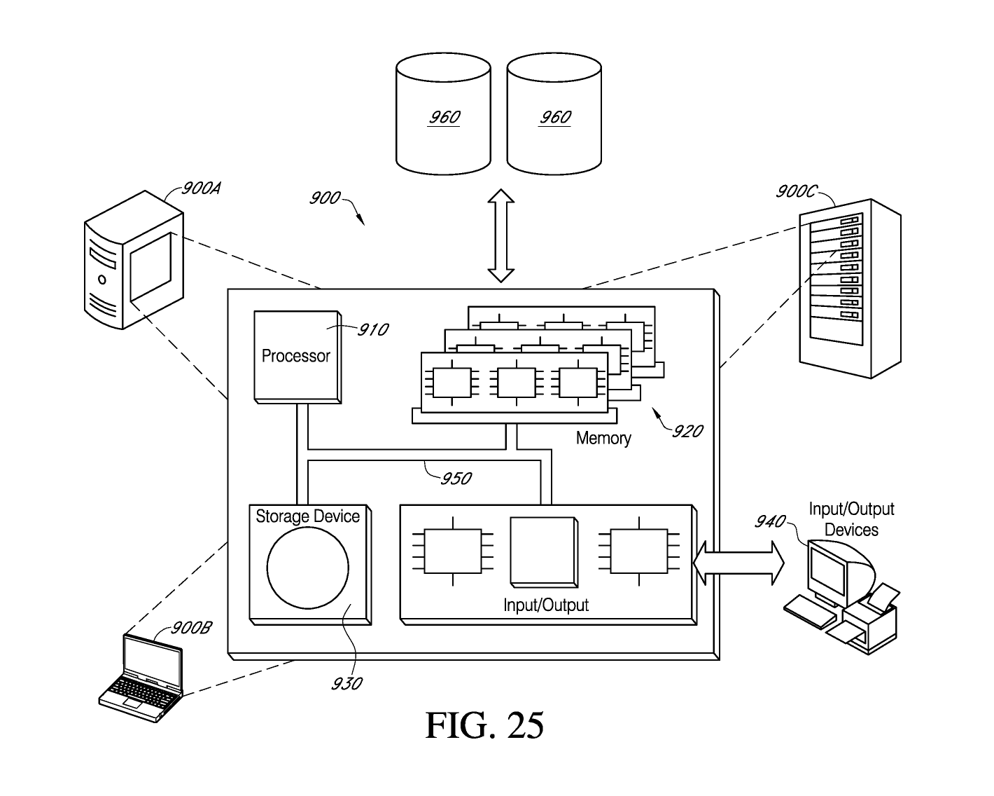

FIG. 25 is a functional block diagram of a general-purpose computing system on which the present embodiments may be implemented according to various aspects of the present disclosure. The computer system 900 may be embodied in at least one of a personal computer (also referred to as a desktop computer) 900A, a portable computer (also referred to as a laptop or notebook computer) 900B, and/or a server 900C. A server is a computer program and/or a machine that waits for requests from other machines or software (clients) and responds to them. A server typically processes data. The purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

The computer system 900 may execute at least some of the operations described above. The computer system 900 may include at least one processor 910, memory 920, at least one storage device 930, and input/output (I/O) devices 940. Some or all of the components 910, 920, 930, 940 may be interconnected via a system bus 950. The processor 910 may be single- or multi-threaded and may have one or more cores. The processor 910 may execute instructions, such as those stored in the memory 920 and/or in the storage device 930. Information may be received and output using one or more I/O devices 940.

The memory 920 may store information, and may be a computer-readable medium, such as volatile or non-volatile memory. The storage device(s) 930 may provide storage for the system 900, and may be a computer-readable medium. In various aspects, the storage device(s) 930 may be a flash memory device, a hard disk device, an optical disk device, a tape device, or any other type of storage device.

The I/O devices 940 may provide input/output operations for the system 900. The I/O devices 940 may include a keyboard, a pointing device, and/or a microphone. The I/O devices 940 may further include a display unit for displaying graphical user interfaces, a speaker, and/or a printer. External data may be stored in one or more accessible external databases 960.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method for activating an audio/video (A/V) recording and communication device that is in a pre-activation mode, the method comprising:
transferring, free of charge, the A/V recording and communication device to a third-party for installation at a structure associated with a user, the A/V recording and communication device being configured to be secured to the structure in the pre-activation mode;
receiving an activation request signal from a client device of the user, the activation request signal including a request to activate the A/V recording and communication device;
in response to receiving the activation request signal, transmitting a request for payment for the A/V recording and communication device; and
upon receiving the requested payment, transmitting an activation signal to the A/V recording and communication device.

2. The method of claim 1, wherein in the pre-activation mode a set of functionalities of the A/V recording and communication device is disabled.

3. The method of claim 2, wherein one functionality in the set of functionalities that is disabled comprises recording video images within a field of view of a camera of the A/V recording and communication device.

4. The method of claim 1, wherein the A/V recording and communication device comprises a button that when pressed, the A/V recording and communication device provides instructions for activating the A/V recording and communication device.

5. The method of claim 4, wherein the instructions are audible and are provided via a speaker of the A/V recording and communication device.

6. The method of claim 4, wherein the instructions are written and are provided via an application executing on a client device.

7. The method of claim 4, wherein the instructions include information about a limited-time discount offer.

8. The method of claim 1 further comprising, in response to the client device connecting to a wireless network broadcast by a wireless communication module of the A/V recording and communication device, providing instructions for activating the A/V recording and communication device.

9. The method of claim 8 further comprising changing a name of the wireless network from a first wireless network name to a second wireless network name.

10. The method of claim 9, wherein the second wireless network name corresponds to a name of a holiday.

11. The method of claim 10, wherein the second wireless network name further corresponds to a discount offer for the holiday.

12. The method of claim 1 further comprising, in response to the client device connecting to a wireless communication module of the A/V recording and communication device while the wireless communication module operates in a discoverable mode according to a short-range wireless protocol, providing instructions for activating the A/V recording and communication device.

13. The method of claim 12, wherein the short-range wireless protocol comprises Bluetooth.

14. The method of claim 1 further comprising detecting, at least at two different occasions, a same person within a field of view of a camera of the A/V recording and communication device.

15. The method of claim 14 further comprising, in response to detecting the same person within the field of view of the camera at the second occasion, providing an announcement via a speaker of the A/V recording and communication device.

16. The method of claim 15, wherein the announcement encourages the person to activate the A/V recording and communication device.

17. The method of claim 1 further comprising, prior to receiving the activation request signal, wirelessly transmitting information to the A/V recording and communication device via a cellular network.

18. The method of claim 1, wherein the A/V recording and communication device comprises a video doorbell.

19. The method of claim 1 further comprising, prior to transmitting the request for payment for the A/V recording and communication device, receiving a device identifier corresponding to the A/V recording and communication device.

20. The method of claim 19 further comprising, in response to receiving the device identifier corresponding to the A/V recording and communication device, determining a payment amount to be transmitted in the request for payment for the A/V recording and communication device based on the received device identifier.
